(19) United States
(12) Patent Application Publication
(10) Pub. No.: US 2005/0287310 A1
(43) Pub. Date: Dec. 29, 2005

(54) Support for electrophotographic image receiving sheet and electrophotographic image recording sheet

(76) Inventor: Shigehisa Tamagawa, Shizuoka (JP)

Correspondence Address: YOUNG & THOMPSON, 745 SOUTH 23RD STREET, 2ND FLOOR, ARLINGTON, VA, 22202, US

(21) Appl. No.: 11/128,246

(22) Filed: May 13, 2005

(30) Foreign Application Priority Data
May 13, 2004 (JP) 2004-143653

(51) Int. Cl. B41M 5/00

(52) U.S. Cl. 428/32.14

(57) ABSTRACT

A support for an image recording paper comprises a support paper and a coating layer formed on one surface thereof on which an image is formed. The coating layer is formed by a film of polypropylene having a density less than 0.88 g/cm³. An image recording paper comprises the support and an image recording layer formed over the coating layer.

### BACKGROUND OF THE INVENTION

1. Field of the Invention

The present invention relates to a support suitable for image recording media used in electrophotographic printing, heat sensitive printing, sublimatic transfer printing, thermal development printing, silver halide photographic printing, ink-jet printing and the like, and an image recording sheet using the support.

2. Description of Related Art

Typically, a support for an image recording sheet used in electrophotographic printing, heat sensitive printing, sublimatic transfer printing, thermal development printing, silver halide photographic printing, ink-jet printing, etc comprises, for example, paper, artificial or synthetic paper, synthetic resin paper, coated paper, laminated paper, etc. Among these paper, a laminated paper with a coating layer such as a polyethylene coating layer formed thereon is preferred in order to provide a print having high image quality, high glossiness and high smoothness.

In recent years, there is a strong demand for an image recording sheet that provides a high quality full color print or a photographic print having high image quality, high glossiness and high smoothness. In order to fulfill the demand, it is essential to realize improvement of flatness of the support. In the case of making prints in, for example, electrophotographic printing, full color prints or photographic picture prints show the tendency to take a higher fixing temperature and a longer fixing time as compared with black and white prints. For this reason, it is required for the support for the image recording sheet to be free of blisters possibly occurring between the support and its coating layer in hot environment which leads to deterioration in the flatness of image recording sheet.

There has been proposed an electrophotographic printing sheet having a polyolefin resin layer formed on each of opposite surfaces of a paper base sheet such as disclosed in Japanese Unexamined Patent Publication No. 2003-76052. The electrophotographic printing sheet is characterized in that the polyolefin resin layer satisfies the following relationship:
(mp−50)2×T>210
T<0.07
where mp is the melt point (° C.) of polyolefin resin and T is the thickness of polyolefin resin layer (mm).

However, since the polyolefin resin has lower heat-resistance, the electrophotographic printing sheet causes blisters between the paper base sheet and the polyolefin coating layers in hot environment, the electrophotographic printing sheet encounters a deterioration in flatness.

Further, there has been proposed an electrophotographic printing sheet having a polypropylene resin layer formed on each of opposite surfaces of a paper base sheet such as disclosed in Japanese Unexamined Patent Publication No. 2003-177565. The electrophotographic printing sheet is characterized in that the polypropylene resin layer at a toner image receptive side has an average surface roughness (Sra) less than 0.05 μm for a cut off wavelength of 5 to 6 mm. The electrophotographic printing sheet is unable to be free of blisters possibly occurring between the support and the polypropylene coating layer in hot environment, resulting in encountering a deterioration in flatness.

### SUMMARY OF THE INVENTION

It is therefore an object of the present invention to provide a high quality support for an image recording paper that prevents an occurrence of blisters in hot environment.

It is another object of the present invention to provide an image recording paper using the high quality support that is free of delamination, peeling, swells of the image recording layer due to blisters and capable of providing high quality prints having high glossiness and high smoothness even when used in full color printing or photographic picture printing.

The foregoing objects of the present invention are achieved by an image recording paper support comprising a support paper and a coating layer formed on at least one surface of the support paper on which an image is formed, the coating layer contains a propylene resin, preferably amorphous, having a density less than 0.88 g/cm³. The coating layer contains a polypropylene resin greater than 5% by mass. 8. It is preferred that the propylene resin has a met flow rate in a range of from 0.5 to 6 g/10 seconds at 230° C.

An image recording paper support may comprise a support paper and a coating layer formed on at least one surface of the support paper on which an image is formed, the coating layer containing an amorphous polyolefin resin preferably comprising a propylene resin. The propylene resin is selected preferably from a group of a polypropylene resin, copolymers of propylene and ethylene and copolymers of propylene and butene. 16. It is preferred that the amorphous polyolefin resin has a met flow rate in a range of from 0.5 to 6 g/10 seconds at 230° C.

The coating layer formed on the one surface of the support paper has a polypropylene resin content preferably greater than 5% by mass. The coating layer formed on the one surface of the support paper may further contain a crystalline propylene resin whose content is preferably less than 95% by mass. Further, the support paper has a density preferably in a range of from 0.85 to 1.15 g/cm³.

It is preferred that the support paper is pressure dried and calendered before application of the coating layer with a calender with a metal roll kept at 140° C.

The foregoing objects are further achieved by an image recording paper comprising the image recording paper support as described above and an image recording layer comprising a resin coating layer formed on the one surface. The image recording paper may further comprises an intermediate layer comprising a resin coating layer between the image recording paper support and the image recording layer. It is preferred to form a coating layer of aqueous polymer, namely a water-dispersant polyester resin or a water-dispersant acryl resin.

The image recording paper is used as at least one of electrophotographic printing paper, heat sensitive printing paper, sublimatic transfer printing paper, thermal development printing paper, silver halide photographic printing paper and ink-jet printing paper.

The image recording paper support that has the coating layer having a density less than 0.88 g/cm³ and contains an amorphous polyolefin resin in the coating layer is capable of preventing an occurrence of blisters between the support and the coating layer in hot environments and, in consequence, keeping flatness.

The image recording paper made from the image recording paper support is free of delamination, peeling and/or swells of the image recording layer and is capable of providing high quality prints with high smoothness and high glossiness even used in full color printing or photographic printing.

### BRIEF DESCRIPTION OF THE DRAWINGS

The foregoing and other objects and features of the present invention will be clearly understood from the following detailed description when read with reference to the accompanying drawing, in which:

FIG. 1 is a schematic view of a press-drying apparatus used in a support paper manufacturing process;

FIG. 2 is a schematic constitutional view of a belt type press drying system including the press-drying apparatus in a support paper manufacturing line; and

FIG. 3 is a schematic constitutional view of a belt fixing device of a printer.

### DETAILED DESCRIPTION OF THE PREFERRED EMBODIMENTS

(Support for Image Recording Paper)

A support for an image recording paper (which is hereinafter referred to as an image recording paper support) of the present invention comprises a paper sheet, a coating layer formed on at least one surface of the paper sheet on which an image is recorded, and other layers as appropriate. In this instance, the paper sheet with the coating layer formed on an image recording surface is a laminated paper sheet.

Paper

Paper for the paper sheet is not specifically bounded by density and may have appropriate densities according to purposes. The paper density is preferred to be in a range of from 0.85 to 1.15 g/cm³. If the lower limit is exceeded, the paper has insufficient stiffness, resulting in deterioration in curling resistance and causing deterioration in flatness of the image receiving sheet. On the other hand, the upper limit is exceeded, the image recording sheet produces irregular gloss that is called blacking.

In this instance, generally, “stiffness” of paper varies depending upon types of beating. Elastic force or an elasticity modulus that paper made after beating attains can be used as a key factor for defining a degree of “stiffness” of the paper. In particular, since a dynamic elasticity modulus of paper that represents a solid state property of viscoelastic material that the paper bears is closely related to paper density, the elasticity modulus of paper is expressed in terms of an acoustic velocity through the paper that is measured by the use of an ultrasonic transducer. Specifically, the elasticity modulus of paper is given by the following expression:
E=ρc²(1−n²)
where E is the dynamic elasticity modulus;
ρis the paper density;
c is the acoustic velocity through paper
n is the Poisson's ratio.

Because the Poisson's ratio of ordinary paper is approximately 0.2, the dynamic elasticity modulus can be approximated by the following expression:
E=ρc²
That is, the elasticity modulus of paper is easily obtained by substituting paper density and an acoustic velocity of paper for ρ and c in the above expression, respectively. An acoustic velocity of paper can be measured on various instruments well known in the art such as, for example, Sonic Tester, Model SST-110 (Nomura Co., Ltd.).

The paper is not bounded by glossiness and may have appropriate degrees of glossiness according to purposes. The degree of glossiness of the paper is preferably 20% or higher in 20 degree glossiness, and more preferably 40% or higher. If the lower limit is exceeded, a printed image possibly loses glossy impression. In this instance, the 20 degree glossiness is measured by the method meeting JIS Z8741.

The paper is not limited by water resistance and may have appropriate water resistances according to purposes. The water resistance is preferably less than 10 g/m², more preferably less than 5 g/m², and most preferably less than 4 g/m², in Cobb size water absorbency.

The paper is bounded neither by structure nor by size and may have and has appropriate structures and sizes according to purposes. The paper may have a single layered structure or multi layered structure.

The paper is not bounded by thickness and may have appropriate thickness according to purposes. The thickness is preferably in a range of from 25 to 500 μm, more preferably in a range of from 50 to 260 μm, and most preferably in a range of from 75 to 220 μm. Further, the paper is not bounded by basic weight and may have an appropriate basic weights according to purposes. The basic weight is preferably in a range of from 50 to 250 g/m² and more preferably in a range of from 100 to 200 g/m².

The paper is not bounded by raw materials and may be made from appropriate materials. Examples of materials for the paper include natural pulp such as coniferous tree pulp or broad leaf tree pulp, synthetic pulp made of plastic such as polyethylene or polypropylene, or mixtures of natural pulp and synthetic pulp. Although the pulp is not bounded by types, it is preferred to use bleached broad leaf tree kraft pulp (LBKP), bleached coniferous tree kraft pulp (NBKP) or broad leaf sulfite pulp (LBSP) in light of improving surface smoothness, rigidity and dimensional stability (curling property) all together to a sufficient and balanced level.

It is preferred to use broad leaf sulfite pulp (LBSP) that have short fiber lengths, as a main constituent. The pulp can be beaten to a pulp slurry (which is referred to as pulp stock in some cases) by, for example, a beater or a refiner. It is allowed to add various additives, e.g. fillers, dry strength intensifying agents, sizing agents, wet strength intensifying agents, fixing agents, pH adjusters and other chemical conditioners, to the pulp slurry as appropriate.

Examples of fillers include calcium carbonate, clay, kaolin, white earths, talc, titanium oxides, diatom earths, barium sulfate, aluminum hydroxides, magnesium hydroxides, etc. Examples of the dry strength intensifying agents include cationic starch, cationic polyacrylamide, anionic polyacrylamide, amphoteric polyacrylamide, carboxy-modified polyvinyl alcohol, etc. Examples of the sizing agents include fatty acid salts, rosin, rosin derivatives such as maleic rosin, paraffin wax, alkylketene dimmers, alkenyl anhydrate succinic acids (ASA), compounds containing high fatty acids such as epoxidized fatty acid salts, etc. Examples of the wet strength intensifying agents include polyamine polyamide epichlorohydrin, melamine resins, urea resins, epoxidized polyamide resins, etc. Examples of the fixing agents include polyvalent metal salts such as aluminum sulfate or aluminum chloride, cationic polymers such as cationic starch, etc. Examples of the pH adjusters include caustic soda, sodium carbonate, etc. Examples of the other chemical conditioners include deforming agents, dyes, slime controlling agents, fluorescent brightening agents, etc. In addition, it is allowed to add softening agents such as described in “New Handbook of Paper Processing” (1980, Paper Chemicals Times), pages 554 and 555 as appropriate.

Processing liquids that are used for a surface sizing process may contain water-soluble polymers, water-resisting agents, pigments, etc. Examples of the water-soluble high molecular compounds include cationic starch, polyvinyl alcohol, carboxy-modified polyvinyl alcohol, acrboxymethyl cellulose, hydroxyethyl cellulose, cellulose sulfate, gelatin, casein, sodium polyacrylate, sodium salts of styrene-maleic anhydrate copolymers, polystyrene sulphonate sodium, etc. Examples of the water-resisting agents include latex emulsions of styrene-butadiene copolymers, ethylene-vinyl acetate copolymers, polyethylene, vinylidene chloride copolymers, or etc, polyamide polyamine epichlorohydrin, etc. Examples of the pigments include calcium carbonate, clay, kaolin, talc, barium sulfate, titanium oxides, etc.

The paper has a Young's modulus ratio of longitudinal Young's modulus (Ea) to transverse Young's modulus preferably in a range of from 1.5 to 2.0 in light of improving rigidity and dimensional stability (curling property) of the electrphographic image recording sheet. If the upper and lower limits are exceeded, the electrphographic image recording sheet is apt to encounter a deterioration in rigidity and/or curling property, resulting in a deterioration in transfer quality.

The paper should preferably have a surface smoothness, more specifically an Oken smoothness, greater than 210 seconds, and more preferably greater than 250 seconds. Although the paper is not bounded by maximum smoothness, nevertheless, the upper limit of surface smoothness should preferably be 600 seconds, and more preferably 500 seconds, in Oken smoothness. If the surface smoothness is less than 21 seconds, prints possibly encounter a deterioration in image quality. The term “Oken smoothness” as used herein shall mean the smoothness measured by the method meeting JAPAN TAPPI Mo. 5.

In order to create a desired average surface roughness on a surface of the paper, it is preferred to use pulp fibers having such a distribution of fiber length as disclosed in, for example, Japanese Unexamined Patent Publication No.58-68037. Specifically, according to the publication, the distribution of fiber length is such that the pulp fibers contain a total part of residual pulp fibers screened with a 24-mesh screen and residual pulp fibers screened with a 42 mesh screen of 20 to 45% by mass and a part of residual pulp fibers screened with 24 mesh screen of less than 5% by mass. The paper can be adjusted in average surface roughness by surface treatment with heat and pressure using a machine calender or a super calender.

[Paper Manufacturing Process]

The paper manufacturing process is not bounded by types and may take any desired types according to purposes. For example, it is preferred to use a pressure drying process. Examples of the pressure drying process include a drying process using a pressing machine (which is called a press drying process) or a drying process using a cast drum (which is called a cast drum drying process). The press drying process is not bounded by types and may be of any desired type as long as it is capable of unstiffening pulp fibers sufficiently to get close to one another and drying pulp stock while pressing it: It is especially preferred to employ, for example, a process of pressing the pulp stock between a couple of hot pressure plates. In the press drying process, it is preferred to dewater using a manual paper making machine and then to adjust a moisture content using a wet press machine in advance of press drying treatment. The paper is not bounded by moisture content and may have any desired moisture content. The moisture content before press drying treatment is preferably in a range of from 30 to 70% by weight and more preferably in a range of from 40 to 60% by weight. Further, the moisture content after press drying treatment is preferably less than 10% by weight and more preferably in a range of from 3 to 8% by weight. The paper may be dried at any desired temperature. The drying temperature for the surface on which an image is formed is preferably in a range of from 100 to 200° C. and more preferably in a range of from 110 to 180° C. If the lower limit is exceeded, it is hard to evaporate moisture sufficiently enough and, as a result, paper fibers are insufficiently intertwist one another, resulting in weak paper strength. On the other hand, if the upper limit is exceeded, the paper is apt to reduce the effectiveness of sizing, and flatness besides. The paper may be pressed at any desired pressure. The pressure is preferred in a range of from 0.05 to 0.5 MPa. If the lower limit is exceeded, the paper is apt to have insufficient flatness due to less flowability. On the other hand, if the upper limit is exceeded, the paper encounters an occurrence of local unevenness concentration. The paper is not bounded by density after press drying treatment and however is preferred to have a density after press drying treatment greater than 0.85 g/cm³, and more preferably in a range from 0.85 to 1.15 g/cm³. If the lower limit is exceeded, the paper is apt to be insufficient in flatness.

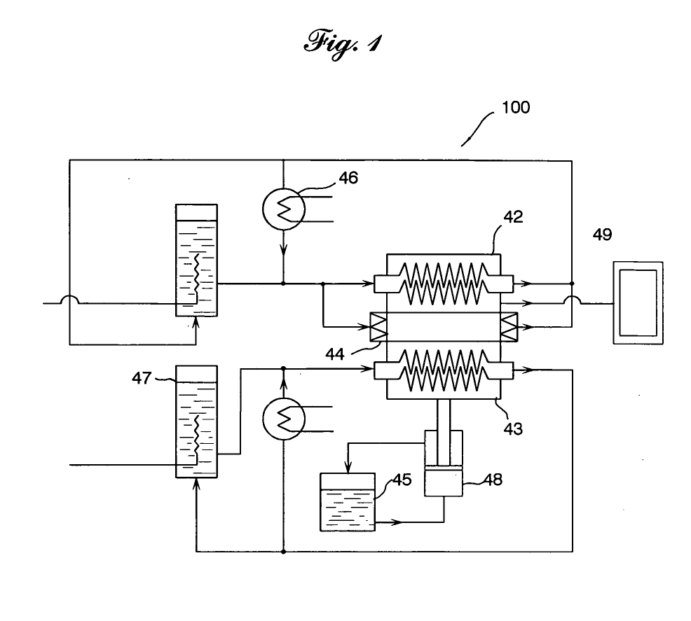

The press drying process is not bounded by types and may employ any desired types of machines according to purposes. For example, for not real paper manufacture purpose but research purposes, it is preferred to employ a Condebelt type of press drying apparatus shown in FIG. 1.

Referring to FIG. 1, the press drying apparatus 100 comprises upper and lower plates 42 and 43, an air tight jacket 44 between the upper and lower plates 42 and 43, and other components as appropriate. The upper and lower plates 42 and 43 are controlled in temperature with oil 47 that is heated by an electrically heating element. In the press drying apparatus 100, wet paper (not shown) made from pulp stock by the use of a manual paper making machine is dewatered by the use of a wet press machine and heat dried and pressed within the air tight jacket 44 by the upper and lower plates 42 and 43. During pressure drying, moisture vapor from the wet paper is removed by a vacuum tank 49, and cooling water 46 is circulated through the upper and lower plates 42 and 43. Pressure is applied to the lower plate 43 by pressure oil 45 through the hydraulic pressure device 48. There are various commercially available press drying devices such as Static Condebelt (VALMET Corporation)

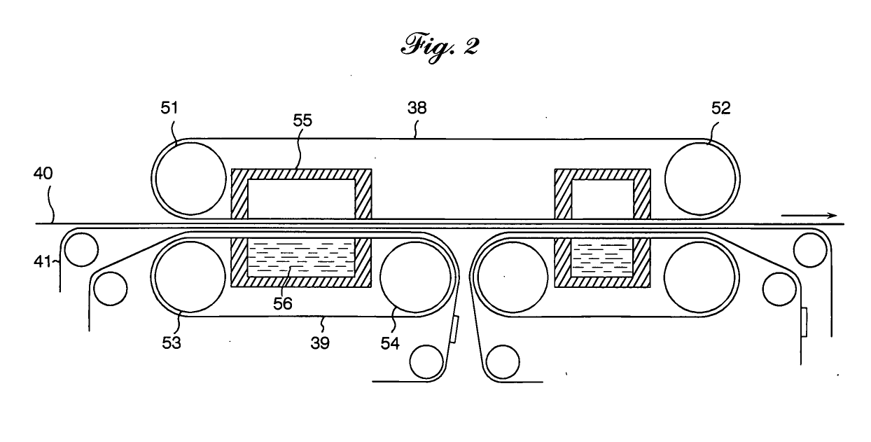

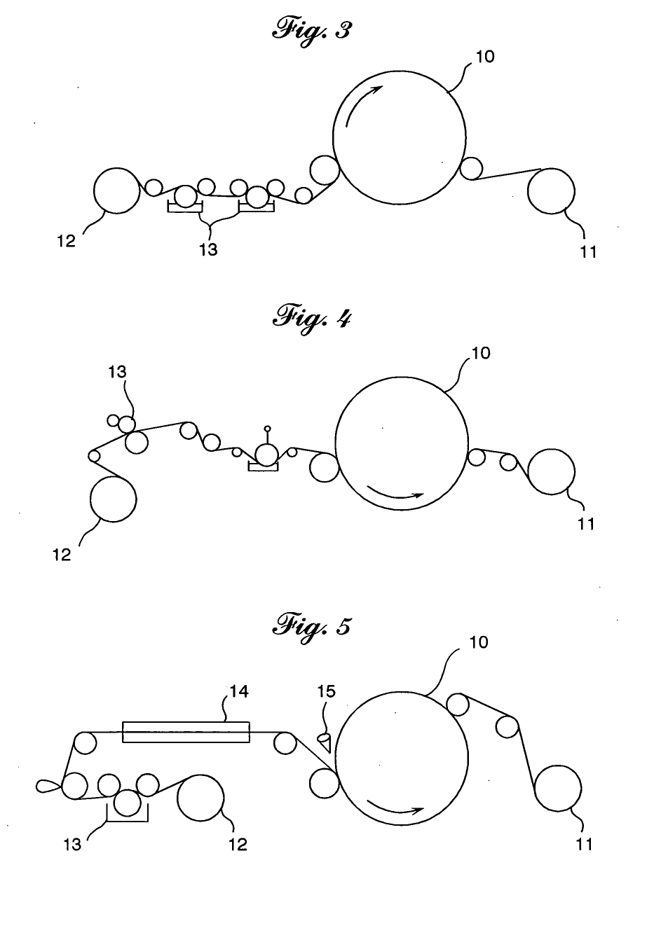

For continuous press drying process in a real paper manufacturing line, it is preferred to employ a belt type of press drying apparatus 200 shown in FIG. 2.

Referring to FIG. 2, the press drying apparatus 200 comprises first and second endless belts 38 and 39 that are airtight and heat conductive, a first pair of rollers 51 and 52 by which the first endless belt 38 travels, a second pair of rollers 53 and 54 by which the second endless belt 39 travels. These first and second endless belts 38 and 39 are disposed so as to travel partly in a parallel path where a drying region. The first endless belt 38 is heated in a heating chamber 55, and the second endless belt 39 is cooled in a cooling chamber 56. A dewatered wet paper web 40 and a looped fabric belt 41 are introduced into between the first and second belts 38 and 39 for pressure drying so that the wet paper 40 is brought into contact with the heated endless belt and the fabric belt 41 is put between the wet paper 40 and the cooled second endless belt 39. Press drying of the wet paper is achieved more favorably and efficiently as compared with conventional drying.

The paper thus press dried shows significant improvement in density, elasticity modulus, tensile strength, so that the paper realizes an image recording paper support excelling in dimensional stability and flatness and the image receiving paper made using the for an image receiving paper support provides high quality images in consequence.

The cast drum drying process is not bounded by types and may take any desired types of machines according to purposes. The cast drum drying machine is capable of transferring its surface texture to the paper, so as thereby to provide the for an image receiving paper support with good glossiness, high flatness and high rigidity, and in consequence, to allow the image receiving paper made using the for an image receiving paper support to provide high quality images. The press drying process and the cast drum drying process may be employed independently or in combination. In light of improvement of glossiness, flatness and rigidity, it is preferred to use these two processes in combination.

Calender Processing

The paper is preferred to be calendar processed after the press drying processing. The calender process is not bounded by types and may take any desired types of processing according to purposes. It is preferred to perform hot soft calendering at a roller surface temperature preferably higher than 110° C., more preferably higher than 150° C., and most preferably higher than 250° C., but lower than 300° C. The calender processing provides the paper with high glossiness.

Examples of the paper include, but are not limited to, bond papers and papers listed in “Fundamentals of Photographic Engineering—Silver Salt Photography—” pages from 223 to 240, edited by Japanese Society of Photograph (1979, Corona Co., Ltd.).

Coating Layer on Image Receiving Surface

It is preferred to form a coating layer according to first or second embodiment described below.

The coating layer of the first embodiment should contain a polypropylene resin having a density less than 0.88 g/cm³ and other component resins as appropriate. The coating layer of the second embodiment should contain an amorphous polyolefin resin and other component resins as appropriate. Determination as to whether a polyolefin resin is amorphous or not can be made by the method meeting JIS K7122 using a differential scanning calorimeter (DSC) such as DSC, Model 220C (Seiko Electronics Industry CO., Ltd.). For example, when a polyolefin resin does not show a peak value greater than 1 J/g resulting from dissolution nor show a peak value greater than 1 J/g resulting from crystallization, the polyolefin resin is determined to be amorphous. The polyolefin resin is not bounded by density and may have any desired densities according to purposes. The polyolefin resin density is preferably less than 0.88 g/cm³, more preferably in a range of from 0.8450 to 0.865 g/cm³. If the polyolefin resin has a density higher than 0.88 g/cm³, the coating layer is possibly insufficient in flexibility. On the other hand, if the polyolefin resin has a density less than 0.840 g/cm³, the coating layer is possibly insufficient in heat resistance. The density of amorphous polyolefin resin is represented by a relative density measured at 23° C. by the method meeting JIS K7122.

The amorphous polyolefin resin is not bounded by species and may take any desired species according to purposes. Examples of the amorphous polyolefin resin include polypropylene, polybutene-1, propylene-ethylene copolymers, butene-1-ethylene copolymers, propylene-butene-1 copolymers, propylene-butene-1-ethylene ternary copolymers, propylene-hexene-1-ethylene ternary copolymers, butene-1-hexene-1-ethylene ternary copolymers, etc. Among them, it is preferred to use amorphous polyolefin resin having 70% by mass of an insoluble of ebullition n-heptane, namely a Soxhlet extracted insoluble with ebullition n-heptane. If the insoluble of ebullition n-heptane exceeds 70% by mass, the polyolefin has only a small amorphous constituent proportion and is possibly hard to create desired flexibility of the coating layer. The coating layer may contain one or more amorphous polyolefin resins described above. Among them, propylene resins are preferred in light of heat resistance.

The propylene resin should have a density less than 0.88 g/cm³, more preferably in a range of from 0.840 to 0.865 g/cm³. If the density is greater than 0.88 g/cm³, the propylene resin is possibly insufficient in softness. On the other hand, if the density is less than 0.840 g/cm³, the propylene resin is possibly insufficient in heat resistance. In this instance, the propylene resin density is represented by a specific gravity measured at 23° C. by the method meeting JIS K7122.

The propylene resin is preferred to have a melt flow rate (MFR) in a range of from 0.5 to 10 g/10 minutes. The melt flow rate is represented by a value measured at 23° C. under a loading of 21.2 N by the method meeting JIS K720. If the lower limit is exceeded, the propylene resin increases its molten viscosity, so as to cause a inhomogeneous mixture with other resins in the coating layer. On the other hand, if the upper limit is exceeded, the propylene resin decreases its molten viscosity, so as to possibly encounter deterioration in formability and mechanical strength.

The propylene resin is preferred to have a melting temperature desirably in a range of from 155 to 175° C. If the lower limit is exceeded, the coating layer possibly encounters deterioration in heat resistance.

The propylene resin is preferred to have a tensile breaking strength preferably lower than 2.0 MPa, more preferably 1.8 MPa and most preferably 1.6 MPa. If the tensile breaking strength is higher than 2.0 MPa, the coating layer possibly encounters deterioration in flexibility. The tensile breaking strength is a value measured by the method meeting JIS K6251.

The polypropylene resin is not bounded by species, and take any desired species. Examples of the propylene resin include homopolymers of polypropylene, copolymers of polypropylene and ethylene, copolymers of propylene and butene, copolymers of polypropylene and olefin, random copolymers of them, block copolymers of them, mixtures of them, etc. Among them, it is preferred to use propylene-butene-1 copolymers containing repeat units derived from propylene (which is hereinafter referred to as propylene units) and repeat units derived from butene-1 (which is hereinafter referred to as butene-1 units) concurrently. Commercially available examples of the propylene resins include Tafseren (Sumitomo Chemical Co., Ltd.), Ubetac UT 2385 and Ubetac UT2780 (Ube Lexen Co., Ltd.), etc. The coating layer may contain one or more resins selected from the above mentioned propylene resins.

The propylene resin content or the amorphous polyolefin resin content of the coating layer is preferably in a range of from 5 to 90% by mass and more preferably in a range of from 10 to 70% by mass. If the lower limit is exceeded, the coating layer loses a favorable adhesion property and sufficient flexibility in hot environment. On the other hand, if the upper limit is exceeded, the coating layer encounters deterioration in heat resistance and adhesion strength.

The coating layer may contain other components. Examples of the components include, but are not limited to, oxidation inhibitors, defogging agents, antistatic agents, nucleus formation agents, fire retardants, etc. and crystalline propylene resins are most preferred. The crystalline propylene resin is not bounded by density and may have any desired density according to purposes. The crystalline propylene resin content of the coating layer is preferably in a range of from 10 to 95% by mass, and more preferably in a range of from 30 to 90% by mass. Examples of the crystalline propylene resin include, but not limited to, polypropylene having an isotactic polypropylene constitution, homopolymers of polypropylene, copolymers of polypropylene and ethylene, copolymers of polypropylene and olefin, random copolymers of them, block copolymers of them, mixture of them, etc. The coating layer is not bounded by thickness and may have a desired thickness in a range of from 15 to 100 μm.

[Other Layers]

Examples of other layers include a coating layer formed on a surface at a side opposite to the side of image receiving surface. Examples of the material for the other layer include, but not limited to, thermoplastic resins and various additives. Examples of the thermoplastic resins include, but not limited to, polyolefin, polyvinyl chloride, polyethylene terephthalate, polystyrene, polymethacrylate, polycarbonate, polyimide, triacetylcellulose, etc. The coating layer may contain these resins independently or in any combination of two or more.

Examples of the polyolefin include, but not limited to, homopolymers of α-olefin such as polyethylene or polypropylene, and mixtures of copolymers of polyethylene and polypropylene. It is especially preferred to use high density polyethylene, low density polyethylene or mixtures of high density polyethylene and low density polyethylene. Among them, it is more preferred to use polypropylene, blends of polypropylene and polyethylene, high density polyethylene, blends of high density polyethylene and low density polyethylene, etc., in light of improvement of heat resistance for the paper, and especially preferred to use the blends of high density polyethylene and low density polyethylene in light of cost and lamination adaptability. The blend proportions by mass of high density polyethylene relative to low density polyethylene is preferably in a range of from 1:9 to 9:1, more preferably in a range of from 2:8 to 8:2, and most preferably in a range from 3:7 to 7:3.

In the case of forming coating layers on both surfaces of the paper, it is preferred to form a back coating layer made from high density polyethylene or a blend of high density polyethylene and low density polyethylene. The polyethylene, high density or low density, is not bounded by molecular weight and is preferred to have a melt index in a range of from 1.0 to 40 g/10 minutes and an aptitude for extraction.

The polyolefin resin is not bounded by molecular weight as long as capable of being coated in extrusion. The molecular weight is preferably in a range of from 20,000 to 200,000. The coating layer is formed in a shape of film or sheet and laminated on one or both surfaces of the paper.

Examples of the additives include white pigments represented by titanium oxides for treatment of providing the paper with white reflective property.

[Structure of Image Recording Paper Support]

The image recording paper support of the present invention is not bounded by structure as long as having a coating layer on the image receiving surface. For example, the image recording paper support may have only the image receiving surface coating layer, may have the other coating layer on the surface opposite to the image receiving surface in addition to the image receiving surface coating layer, may have the image receiving surface coating layer on both surfaces.

[Process of Manufacturing Image Recording Paper Support]

When the image recording paper support is made from laminated paper, no limitation is imposed on the manufacturing method. After applying corona discharge treatment to the paper, a coating layer is formed on at least the image receiving surface of the paper in extrusion coating. In order to improve a curling balance between the opposite surfaces of the paper, a coating layer is formed on a back surface opposite to the image receiving surface in extrusion coating. Examples of extrusion coating equipment include, but not limited to, polyolefin extrusion machines and laminators. Specifically, the process of manufacturing the image recording paper support for an image recording paper comprises the steps of melt kneading materials for the coating layers with an extrusion machine, extruding the molten material with a die lip, laminating a coating layer on one or both of surfaces of the paper, and applying heat treat to the laminated paper. The lamination is performed by extruding the coating material over the surface of the paper, pressure joining a film of the coating material onto the paper, bonding a film of the coating material to the paper with an adhesion, etc. After lamination, it is preferred to apply heat treatment to the paper with the coating layer or layers formed thereon.

In order to prevent the paper from having got fine irregularities on the image recording surface coating layer, it is preferred to extrude the coating material at a temperature comparatively higher than usual through a die lip and to use a flex roll for cooling the coating layer. An example of the flex roll is a film sheet forming roll comprising an elastic external cylinder made of an elastically deformable metal film and spindles closing opposite ends of the external cylinder. It is preferred to extrude a molten material for the coating layer of the first embodiment or of the second embodiment at a temperature preferably in, but not limited to, a range of from 210 to 280° C., and more preferably in a range of from 220 to 270° C. in the case of using homopolymers of propylene resin.

The heat treatment is performed using a heating roll, a heating furnace, a far-infrared heater or a hot air heater. Among them, it is preferred to employ the heating roll or the far-infrared heater. The heating treatment is not bounded by heating temperatures and may be performed at different heating temperatures according to compositions of the coating material. For example, it is preferred to adjust the heating sheet such as a heating roll in temperature so as to heat a sheet surface to a temperature preferably in a range of from 130 to 166° C., and more preferably in a range of from 135 to 165° C. in the case of using propylene copolymers. The heat treatment is not bounded by treating time. The treating time is preferably in a range of from one to 300 seconds, and more preferably in a range of from one to 120 seconds. The term “heating time” as used herein shall mean the heating time after the sheet surface has attained a temperature in that range. In the case of using the heating roll, the heating time is referred to the total time for which the sheet remains in contact with the heating roll after the sheet surface has attained a temperature in that range. Further, in the case of using the heating furnace, the heating time is referred to the time for which the sheet is left in the heating furnace after the sheet surface has attained a temperature in that range.

(Image Recording Paper)

The image recording paper of the present invention comprises the image recording paper support previously described and an image recording layer formed on the image recording paper support, and if necessary, other layers.

Image Recording Layer

The image recording layer is different according to intended use of the image recording paper. For example, the image recording layer is a toner image receiving layer for an electrophotographic printing paper, a heat coloring layer for a heat sensitive printing paper, a heat diffusion dye layer for a sublimation transfer printing paper, a heat fusible ink layer for a thermal transfer printing paper, yellow (Y), magenta (M) and cyan (C) color development layers for a silver salt photographic paper, a color material receptor layer capable of receiving aqueous ink or oil-based ink for an ink-jet printing paper, etc. The image recording layer is not bounded by materials and may comprise a resin coating layer which contains various components as appropriate.

Polymers for the resin coating layer are not bounded by species as long as prepared as a coating liquid containing resin components. However, it is preferred to use thermoplastic resins. Examples of the thermoplastic resins include, but not limited to, (1) polyolefin resins, (2) polystyrene resins, (3) acrylic resins, (4) polyvinyl acetate or derivatives of polyvinyl acetate, (5) polyamide resins, (6) polyester resins, (7) polycarbonate resins, (8) polyether resins or acetal resins, and (9) other resins. These resins may be selectively used independently or in any combination of two or more.

Examples of the polyolefin resins include polyolefin resins such as polyethylene and polypropylene, copolymer resins of olefin such as ethylene or propylene polymerized with vinyl monomers. Examples of the copolymer resins of olefin and vinyl monomers include ethylene-vinyl acetate copolymers and ionomer resins that are copolymers polymerized with an acrylic acid or a methacrylic acid. In this instance, examples of derivatives of polyolefin resin include chlorinated polyethylene and chlorosulfonated polyethylene.

Examples of the polystyrene resins include polystyrene resins, styrene-isobutylene copolymers, styrene-isobutylene copolymers, acrylonitrile-styrene copolymers (AS resins), acrylonitrile-butadiene-styrene copolymers (ABS resins), polystyrene-maleic anhydride resins, etc.

Examples of the acrylic resins include polyacrylic acids or their ester, polymethacrylic acids or their ester, polyacrylonitrile, polyacrylamide, etc. These ester are different in property according to ester groups. Further, examples of them include copolymers polymerized with other monomers such as acrylic acids, methacrylic acids, styrene, vinyl acetate, etc. The polyacrylonitrile is used in the form of a copolymer of the AS resin or ABS resin rather than in the form of homopolymer.

Examples of the polyvinyl acetate or their derivatives include polyvinyl acetate, polyvinyl alcohol derived by saponifying polyvinyl acetate, and polyvinyl acetal resins derived by reacting polyvinyl alcohol to aldehyde such as formaldehyde, acetaldehyde, butylaldehyde, etc.

The polyamide resins, that are condensation polymers with diamine and dibasic acid, include, for example, 6-nylon and 6,6-nylon.

The polyester resins can be produced from condensation polymerization with acid and alcohol. The polyester resins are significantly different in property according to combinations of acid and alcohol. Examples of the polyester resins include general purpose resins consist of aromatic dibasic acid and dihydric alcohol such as polyethylene terephthalate or polybutylene terephthalate.

General examples of the polycarbonate resins include polycarbonic acid ester derived from bisphenol A and phosgene.

Examples of the polyether resins include polyethylene oxides and polypropylene oxides. Further, examples of the acetal resins include ring opening polymers such as polyoxymethylene.

Examples of the other resins include polyaddition polyurethane resins.

[Aqueous Polymer]

It is preferred to form the resin coating layer using aqueous polymers such as water-dispersant polymers and water-soluble polymers for the following reasons. That is, the aqueous polymer does not emit an organic solvent in a coating and drying process, excels at environmental adaptability and suitability for working and is suitable for a solvent for a releasing agent that is blended in an image recording layer, in particular a toner image receiving layer. Further, the aqueous polymer is easily bled onto a surface in the coating and drying process so as thereby to bring about an effect of a releasing agent and is stable and excels at adaptability to manufacturing process. It is more preferred to use aqueous polymers such as self-dispersant aqueous polyester emulsions or water dispersant acryl resins. That is, because these self-dispersant aqueous polyester emulsions and water dispersant acryl resins are of a self-dispersant type that does not contain a surface active agent, they are less hydroscopic even in a highly humid atmosphere, shows a small drop in softening point due to moisture, is prevented from causing offset during fixation of the resin coating layer and adhesion defects between papers during storage. Furthermore, because the polyester resin is apt to affect a molecular geometry that is high in cohesive energy, they take a low elastic or low viscous molten state in a fixation process of an electrophotographic printing paper with a toner image receiving layer while having sufficient hardness in conservative environment, so as to provide a sufficiently high quality image resulting from disposition of toner particles in the image receiving layer.

The aqueous polymer is not bounded by chemical composition, bond-structure, molecular geometry, molecular weight, molecular weight distribution, and conformation. Examples of a hydrating group for the aqueous thermoplastic resin include a sulfonic acid group, a hydroxyl group, a carboxylic acid group, an amino group, an amid group, an ether group, etc.

Examples of the water-dispersant polymers include water-dispersant resins such as water-dispersant acrylic resins, water-dispersant polyester resins, water-dispersant polystyrene resins or water-dispersant urethane resins; water-dispersant emulsions such as acrylic resin emulsions, polyvinyl acetate emulsions or styrene butadiene rubber (SBR) emulsions; water-dispersions or emulsions of resins having ester bonds, polyurethane resins, polyamide resins, polysulfone resins, polyvinyl chloride resins, polyvinylbutyral, polycaprolactam resins or polyolefin resins; copolymers or mixtures of these resins or cation modified products of these resins. These resins may be used independently or in any combination of two or more.

Examples of the water-dispersant emulsions include, but not limited to, water-dispersanr polyurethane emulsions, water-dispersant polyester emulsions, chloroprene emulsions, styrene-butadiene emulsions, nitrile-butadiene emulsions, butadiene emulsions, vinyl chloride emulsions, vinylpyridine-styrene-butadiene emulsions, polybutene emulsions, polyethylene emulsions, vinyl acetate emulsions, ethylene-vinyl acetate emulsions, vinylidene chloride emulsions, methylemetacrylate-butadiene emulsions, etc. Among them, it is preferred to use water-dispersant polyester emulsions.

Commercially available examples of the water-dispersant polymers include a Vyronal series of polyester polymers (Toyobo Co., Ltd.), a Pesuresin A series of polyester polymers (Takamatsu Oil & Fats Co., Ltd.), a Tafuton UE series of polyester polymers (Kao Co., Ltd.), a Polyester WR series of polyester polymers (Nippon Synthetic Chemical Industry Co., Ltd.), an Eliel series of polyester polymers (Unitika Ltd.), Hyros XE series of acrylic polymers, Hyros KE series of acrylic polymers and Hyros PE series of acrylic polymers (Seiko Chemical Industry Co., Ltd.), and Jurimar ET series of acrylic polymers (Nippon Fine Chemical Co., Ltd.).

Examples of the water-soluble polymers include, but not limited to, polyvinyl alcohol, carboxy-modified polyvinyl alcohol, carboxy methylcellulose, hydroxyethyl cellulose, cellulose sulfate, polyethylene oxides, gelatin, cationic starch, casein, sodium polyacrylate, styrene-sodium maleic anhydride copolymers, sodium polystyrene sulfate, etc. Among them, the polyethylene oxides are especially suitable. Further, examples of the water-soluble polymers include those disclosed in Research Disclosures Vol. 17, No. 643, page 26; Vol. 18, No. 716, page 651, No. 307, No. 105, pages 873-874; and Japanese Unexamined Patent Publication No. 64-13546, pages 71-75.

Specific examples of the water-soluble polymers include vinylpyrrolidone-vinyle acetate copolymers, styrene-vinylpyrrolidone copolymers, styrene-maleic anhydride copolymers, water-soluble polyester, water-soluble acryl, water-soluble polyurethane, water-soluble nylon, water-soluble epoxy resins, etc. Examples of gelatins include lime-treated gelatins, acid-treated gelatins, what is called delimed gelatins that have decreased calcium contents.

Commercially available examples of the water-soluble polymers includewater-soluble polyester such as various types of Pluscoat polyester (Gao Chemical Industry Co., Ltd.) or a Fintex ES series of polyester (Dainippon Ink & Chemical Inc.), and water-soluble acryl such as a Jurimar AT series of acryl (Nippon Fine Chemical Co., Ltd.), Fintex 6161 and Fintex K-96 series of acryl (Dainippon Ink & Chemical Inc.), Hyros NL-1189 and Hyros BH-997L series of acryl (Seiko Chemical Industry Co., Ltd.), etc.

The aqueous polymer content of the toner image receiving layer is, but not limited to, preferably greater than 20% by mass, and more preferably in a range of from 30 to 100% by mass. as used herein shall mean and refer to for example, Japanese Unexamined Patent Publication Nos. 5-127413, 8-194394, 8-334915, 8-334916, 9-171265 and 10-221877.

Examples of the other additives that may be contained in the resin coating layer include cross-linking agent, UV or EB curing agents, and additives such as plasticizers, lubricant, releasing agents, fillers, electrostatic charge control agents, emulsifiers, dispersing agents, etc.

Printing Paper

The image recording paper support is suitably used as printing paper, in particular offset printing paper, relief printing paper, gravure printing paper, electrophotographic printing paper. It is preferred for the printing paper to have a high mechanical strength in light of applying ink with a printing machine. The printing paper may have the resin coating layer formed thereon.

Electrophotographic Printing Paper

The electrophotographic printing paper comprises the image recording paper support and a toner image receiving layer as the image recording layer, and other layers besides as appropriate. Each of these layers may be single layered or multi-layered.

[Toner Image Receiving Layer]

The electrophotographic paper of comprises the base paper (base support) described above and at least one toner image receiving layer formed on at least one of opposite surfaces of the base paper and, if necessary, may further comprise additional layers including, for example, a surface protective layer, a backing layer, an intermediate layer, an undercoating layer, a cushioning layer, an electrostatic charge control or antistatic layer, a reflective layer, a color tincture adjusting layer, a storage stability improvement layer, an anti-adhesion layer, an anti-curling layer, a smoothing layer, etc. Each of these layers may have a single layer structure or a multi-layered structure.

[Toner Image Receiving Layer]

The toner image receiving layer is the layer that accepts a color toner or a black toner for image formation. The toner image receiving layer accepts a toner image from a developing drum or an intermediate transfer medium with static electricity or pressure in an image transfer process and then immobilizes the toner image with heat or pressure in a fixing process. The toner image receiving layer has an optical transmittance desirably less than 78%, more desirably less than 73%, and most desirably less than 72% in light of providing electrophotographic paper with a feel like a photographic print. In this instance, the optical transmittance can be found by, for example, measuring an optical transmittance of a sample toner coating having the same thickness as the toner image receiving layer in question formed on a polyethylene terephthalate film of 100 μm in thickness on a direct reading Hayes meter, for example HGM-2DP (Suga Testing Machine Co., Ltd.).

It is preferred for the toner image receiving layer to have a 180 degree exfoliation strength with respect to a fixing member of an image forming apparatus less than 0.1 N/25 mm, and more preferably less than 0.041 N/25 mm, at a fixing temperature. The 180 degree exfoliation strength is measured using a surface material of the fixing member by the method meeting JIS K6887.

It is preferred for the toner image receiving layer to have a high degree of whiteness, specifically higher than 85% when measured by the method meeting JIS P8123. It is further preferred for the toner image receiving layer to have a spectral reflection coefficient higher than 85% in a wavelength range of from 440 to 640 nm and a difference between a peak and a bottom spectral reflection coefficient preferably less than 5% in the same wavelength range. Further, it is preferred for the toner image receiving layer to have a spectral reflection coefficient higher than 85% in a wavelength range of from 400 to 700 nm and a difference between a peak and a bottom spectral reflection coefficient less than 5% in the same wavelength range.

More specifically, when specifying the degree of whiteness in terms of CIE 1976 (L*a*b*) color space, it is preferred for the toner image receiving layer to have an L* value desirably greater than 80, more desirably greater than 85 and most desirably greater than 90. The toner image receiving layer has a white tincture that is preferred as neutral as possible and represented by a value of (a*)²+(b*)² desirably less than 50, more desirably less than 18 and most desirably less than 5, in terms of CIE 1976 (L*a*b*) color space.

It is preferred for the toner image receiving layer to have a high glossiness after image formation, specifically, a 45 degree glossiness between 60 and 110, and a lower limit 45 degree glossiness higher than 75, more preferably higher than 90, over a range from a white state in which no toner is present) to a black state in which a toner is present at the maximum density. However, If the 45 degree glossiness exceeds 110, the toner image receiving layer shows metallic luster which leads to undesirable image quality. The 45 degree glossiness is measured by the method meeting JIS Z8741.

It is preferred for the toner image receiving layer to have a high degree of smoothness after fixation. The smoothness after fixation is preferably less than 3 μm, more desirably less than 1 μm, and most desirably less than 0.5 μm, in terms of arithmetic average roughness (Ra) over a range of from the white state to the black state. The arithmetic average roughness is measured by the method meeting JIS B0601, B0651 or B0652.

It is further preferred that the toner image receiving layer satisfies at least one, desirably tow or more, and more desirably all, of the following solid state properties (1) to (6):
(1) Melting temperature (Tm): Desirably higher than 30° C., but within +20° C. from a melting temperature of a toner
(2) Temperature at which the toner image receiving layer attains viscosity of 1×10⁵ cp: Desirably higher than 40° C. but lower than that of toner
(3) Elastic modulus (G) at a fixing temperature of the toner image receiving layer: preferably 1×10²˜1×10⁵ Pa in terms of storage modulus (G′) and 1×10²˜1×10⁵ Pa in terms of loss modulus (G″)
(4) Loss tangent (G″/G′) at a fixing temperature of the toner image receiving layer which refers to a ration of the loss modulus (G″) relative to the storage modulus (G′): preferably 0.01˜10
(5) Storage modulus (G′) at a fixing temperature of the toner image receiving layer with respect to storage modulus (G′) at a fixing temperature of toner: preferably in a range from −50 Pa to +2500 Pa from the storage modulus (G′) at a fixing temperature of toner
(6) Angle of inclination of molten toner on the toner image receiving layer: preferably less than 50° and more desirably less than 40°.

Further, it is preferred that the toner image receiving layer satisfies the solid state properties disclosed in, for example, Japanese Patent Publication 2788358, Japanese Unexamined Patent Publication Nos. 7-248637, 8-305067 and 10-23889.

It is preferred for the toner image receiving layer to have a surface electrical resistivity desirably in a range of from 1×10⁶ to 1×10¹⁵ Ω/cm² at 25° C. under a relative humidity of 65%.

If the lower surface electrical resistivity of 1×10⁶ Ω/cm² is exceeded, this indicates that an insufficient amount of toner is transferred to the toner image receiving layer, then a toner image is apt to diminish in density. On the other hand, if the upper surface electrical resistivity of 1×10¹⁵ Ω/cm² is exceeded, electrostatic charges generating during image transfer is too much to transfer a sufficient amount of toner to the toner image receiving layer so as thereby to lead to an insufficient density of toner image and generation of electrostatic that causes easy adhesion of dust to an elctrophotographic paper during handling the elctrophotographic paper. In addition, if the toner image receiving layer that does not satisfy the requirement of surface electrical resistivity causes the electrophotographic paper to be susceptible to misfeeding, double feeding, generation of discharge prints and an occurrence of fractional absence of toner transfer. In this instance, the surface electrical resistivity can be found by measuring a surface electrical resistivity of a sample at 20° C. under a relative humidity of 65% by the method meeting JIS K 6911 using a resistivity meter, for example, R8340 manufactured by Advantest Co., Ltd., after a lapse of one minute from impression of a voltage of 100V on the sample subsequently to controlling damp under the same temperature and humidity condition for 8 hours.

It is preferred for the toner image receiving layer to be formed by the resin coating layer described previously. The toner image receiving layer contains at least thermoplastic resins and, if desired, other additives.

<Polymer For Toner Image Receiving Layer>

The polymers may be used independently or in combination of two or more as long as satisfying the solid state properties of the toner image receiving layer described above.

It is preferred to use a polymer for the toner image receiving layer that has a molecular weight greater than a thermoplastic resin used for a toner. However, this relationship regarding molecular weight is not always preferred according to the relationship of thermodynamic characteristics between the thermoplastic resin used for the toner and the polymer used for the toner image receiving layer. Taking an instance, in the case where the polymer for the toner image receiving layer has a softening temperature higher than the thermoplastic resin for the toner, it is possibly preferred in some cases that the polymer has a molecular weight equal to or less than the thermoplastic resin.

It is preferred to use a polymer for the toner image receiving layer comprising a mixture of different polymers identical in composition but different in average molecular weight It is preferred for the polymer to have the relationship regarding molecular weight of the thermoplastic resins for a toner such as disclosed in Japanese Unexamined Patent Publication No. 8-334915. It is further preferred for the polymer for the toner image receiving layer to have a molecular weight distribution wider than the thermoplastic resin for the toner. In this instance, it is preferred that the polymer satisfies solid state properties such as disclosed in Japanese Unexamined Patent Publication Nos. 5-127413, 8-194394, 8-334915, 8-334916, 9-171265 and 10-221877.

It is preferred that the polymer for the toner image receiving layer satisfies the following properties (1) to (6) in relation to a polymer for an intermediate layer which will be described later.
(1) The polymer for the image receiving layer has a softening temperature (Ts) higher than the polymer for the intermediate layer preferably by 10° C. or more, and more preferably by 20° C. or more. This softening temperature adjustment enables control of glossiness of the image receiving layer. In this instance, the softening temperature is measured by the method meeting JIS K7210.
(2) The polymer for the image receiving layer has a ½ softening temperature higher than the polymer for the intermediate layer preferably by 10° C. or more, and more preferably by 20° C. or more. This softening temperature adjustment enables control of glossiness of the image receiving layer.
(3) The polymer for the image receiving layer has a flow starting temperature (Tfb) higher than the polymer for the intermediate layer preferably by 10° C. or more, and more preferably by 20° C. or more. This flow start temperature adjustment enables control of glossiness of the image receiving layer.
(4) The polymer for the image receiving layer has a viscosity at a fixing temperature preferably more than three times, and more preferably more than ten times, as high as the polymer for the intermediate layer. This viscosity adjustment enables control of glossiness of the image receiving layer.
(5) The polymer for the image receiving layer has a storage modulus (G′) at a fixing temperature preferably more than three times, and more preferably more than ten times, as high as the polymer for the intermediate layer. This storage modulus adjustment enables control of glossiness of the image receiving layer.
(6) The polymer for the image receiving layer has a loss modulus (G′) at a fixing temperature preferably more than three times, and more preferably more than ten times, as high as the polymer for the intermediate layer. This loss modulus adjustment enables control of glossiness of the image receiving layer.

Further, it is preferred for the polymer for the image receiving layer to have a number average molecular weight smaller than the polymer for the intermediate layer preferably by 1,000 to 100,000° C., and more preferably by 1,000 to 10,000. This molecular weight adjustment enables control of glossiness of the image receiving layer. It is also preferred for the polymer for the image receiving layer to have a molecular weight distribution narrower than the polymer for the intermediate layer preferably by 0.2 to 5. This molecular weight distribution adjustment enables control of glossiness of the image receiving layer.

Examples of the thermoplastic resin include those enumerated in connection with the resin coating layer fomiing the image receiving layer, namely resins having ester bonds, polyurethane resins, polyamide resins, polysulfone resins, polyvinyl chloride resins, polyvinylbutyral, polycaprolactam resins or polyolefin resins. In addition, mixtures or copolymers of these polymers are allowed to be used. The polymers for the image receiving layer may be used independently or in any combination of two or more.

Water-dispersant polymers or water-soluble polymers are favorably used as the polymer for the toner image receiving layer for the following reasons. That is, these aqueous polymer do not emit an organic solvent in a coating and drying process, so as to excel at environmental adaptability and suitability for working, and a releasing agent such as wax is generally hard to dissolve in a solvent at an ambient temperature and is dissolved in a solvent such as water or an organic solvent in advance of use. Further, the water-soluble type of polymer is stable and excels at adaptability to manufacturing process, and aqueous coating easily bleeds onto a surface in the coating and drying process so as thereby to bring about an effect of a releasing agent.

The aqueous resin is not bounded by its component, bond-structure, molecular geometry, molecular weight, molecular weight distribution, etc. as long as it is a water-soluble polymer or a water-dispersant polymer. Examples of aqueous groups of the polymer include a sulfonic acid groups, a hydroxyl group, carboxylic acid group, an amino acid group, an amide group, an ether group, etc.

Examples of the water-dispersant polymers include resin dispersions, copolymers, mixtures and cation modified products of the polymers (1) to (9) enumerated in the paragraph under the caption of “Image Receiving Layer.” These polymers may be used independently or in any combination of two or more. Synthesized water-dispersant polymers may be used. Commercially available examples of the synthesized water-dispersant polymers a Vyronal series of polyester polymers (Toyobo Co., Ltd.), a Pesuresin A series of polyester polymers (Takamatsu Oil & Fats Co., Ltd.), a Tafuton UE series of polyester polymers (Kao Co., Ltd.), a Polyester WR series of polyester polymers (Nippon Synthetic Chemical Industry Co., Ltd.), an Eliel series of polyester polymers (Unitika Ltd.), Hyros XE series of acrylic polymers, Hyros KE series of acrylic polymers and Hyros PE series of acrylic polymers (Seiko Chemical Industry Co., Ltd.), and Jurimar ET series of acrylic polymers (Nippon Fine Chemical Co., Ltd.).

The water-dispersant emulsions are not bounded by species as long as having an average volumetric particle size greater than 20 nm. Examples of the water-dispersant emulsions include water-dispersant polyurethane emulsions, water-dispersant polyester emulsions, chloroprene emulsions, styrene-butadiene emulsions, nitrile-butadiene emulsions, butadiene emulsions, vinyl chloride emulsions, vinylpyridine-styrene-butadiene emulsions, polybutene emulsions, polyethylene emulsions, vinyl acetate emulsions, ethylene-vinyl acetate emulsions, vinylidene chloride emulsions, methylemetacrylate-butadiene emulsions, etc. Among them, it is preferred to use water-dispersant polyester emulsions.

It is preferred that the water-dispersant polyester emulsion is of a self-dispersant aqueous type. Among them, carboxyl group contained self-dispersant aqueous polyester resin emulsions are especially preferred. In this instance, the self-dispersant aqueous polyester emulsion as used herein shall mean and refer to aqueous emulsions including polyester resins capable of self-dispersing in aqueous solvent without the aid of emulsifiers or the like, and the carboxyl group contained self-dispersant aqueous polyester resin emulsion as used herein shall mean and refer to an aqueous emulsion containing polyester resins containing carboxyl groups as a hydrophilic group and capable of self-dispersing in an aqueous solvent.

It is preferred that the self-dispersant aqueous polyester emulsion satisfies the following properties (1) to (4) in relation to a polymer for an intermediate layer which will be described later. This is because that, since the self-dispersant aqueous polyester emulsion contains no surface active agent, it is less hydroscopic even in a highly humid atmosphere, shows a small drop in softening point due to moisture, and is prevented from causing offset during fixation of the resin coating layer and adhesion defects between papers during storage. Furthermore, because the aqueous polyester emulsion is apt to affect a molecular geometry that is high in cohesive energy, it takes a low elastic or low viscous molten state in a fixation process of an electrophotographic printing paper with a toner image receiving layer while having sufficient hardness in a conservative environment, so as to provide sufficiently high image quality resulting from disposition of toner particles in the image receiving layer.
(1) Number-average molecular weight (Mn): preferably in a range of from 5,000 to 10,000, and more preferably in a range of from 5,000 to 7,000
(2) Molecular weight distribution (weight-average molecular weight Mw/number-average molecular weight Mn): preferably less than 4, more preferably equal to or less than 3
(3) Glass transition temperature (Tg): preferably in a range of from 40 to 100° C., and more preferably in a range of from 50 to 80° C.
(4) Volumetric-average particle size: preferably in a range of from 20 to 200 nm, and more preferably in a range of from 40 to 150 nm

It is preferred that the toner image receiving layer contains an aqueous emulsion in a range of from 10 to 90% by mass, and more preferably in a range of from 10 to 70% by weight.

The water-soluble polymers are not bounded by weight-average molecular weight (Mw) as long as having a weight-average molecular weight (Mw) less than 400,000 and may be synthesized. It is allowed to use commercially available water soluble polymers such as polyvinyl alcohol, carboxy modified polyvinyl alcohol, carboxymethyl cellulose, hydroxyethyl cellulose, cellulose sulfate, polyethylene oxides, gelatin, cationic starch, casein, sodium polyacrylate, sodium styrene-maleic anhydride copolymers, polystyrene sodium sulfonate, etc. Among them, it is preferred to use polyethylene oxides.

More specifically, commercially available examples of the water soluble polymers include a Pluscoat series of water-soluble polymers (Gao Chemical Industry Co., Ltd.), a Fintex ES series of water-soluble polymers (Dainippon Ink & Chemical Inc.), a Jurimar AT series of water-soluble acryl (Nippon Fine Chemical Co., Ltd.), Fintex 6161 and K-96 series of water-soluble acryl (Dainippon Ink & Chemical Inc.), and Hyros NL-1189 and Hyros BH-997L series of water-soluble acryl (Seiko Chemical Industry Co., Ltd.), etc.

Further examples of the water-soluble polymers include those disclosed in Research Disclosure (RD) Vol. 17, No. 643, page 26; Vol. 18, No. 716, page 651; Vol. 307, No. 105, pages 873 and 874; and Japanese Unexamined Patent Publication No. 64-13546.

The toner image receiving layer is not bounded by and preferred to have a polymer content in a range of from 0.5 to 2 g/m².

The thermoplastic resins may be used in any combination with other polymers. In such a case, the thermoplastic resin content should be greater than the polymer content.

The toner image receiving layer may be formed from either one of the water-dispersant emulsion and the water-soluble polymer independently or from both of them. In the latter case, it is preferred that the adsorption of the water-soluble polymer in the toner image receiving layer is less than 2% by mass. If the adsorption of the water-soluble polymer exceeds 2% by mass, the coating liquid possibly agglutinates. The adsorption of water-soluble polymer in mass percent is found by sentrifugalizing a polyethylene oxide (water-soluble polymer) molten in a clear supernatant liquid of a mixture of a water-dispersant emulsion and water-soluble polymer mixed at a mass ratio of 100:17 and determining the quantity of the polyethylene oxide in nuclear magnetic resonance analysis (NMR). If the adsorption of water-soluble polymer is in a range of from 2 to 5% by mass, this indicates an occurrence of depression cohesion, and if the adsorption of water-soluble polymer is greater than 30% by mass, this indicates an occurrence of adhesion due to adsorption and cross-linkage. It is preferred that the mass ratio of the water-dispersant emulsion relative to the water-soluble polymer is in a range of from 100 tol, and more preferably in a range of from 10 to 1. It is preferred that the toner image receiving layer has a polymer content preferably higher than 10% by mass, more preferably higher than 30% by mass, and most preferably higher than 50% by mass.

<Other Components>

Example of the other components that are allowed to be contained in the toner image receiving layer include releasing agents, plasticizers, coloring agents, fillers, cross-linking agents, electrostatic charge control agents, and other additives.

Releasing Agent

The releasing agents are blended in the toner image receiving layer in order to prevent an occurrence of offsets. The releasing agents are not bounded by species as long as being capable of forming a layer resulting from hot solution at a fixing temperature with the consequence that the releasing agent is separated out and unevenly distributed on a surface of the toner image receiving layer, and cold solidification.

Examples of the releasing agents include silicon compounds, fluorine compounds, waxes and matting agents. Specifically, examples of the releasing agents include waxes disclosed in “Revised Edition: Property and Application of Wax” (published by Koushobou), silicone compounds disclosed in “Silicone Handbook” (published by Nikkan Kogyo Shinbun), and silicone compounds, fluorine compounds and waxes (except for natural waxes) that are used for toners such as disclose in Japanese Patent Nos. 2,838,498 and 2,949,558; Japanese Patent Publication Nos. 59-38581 and 4-32380; Japanese Unexamined Patent Publication Nos. 50-117433, 52-52640, 57-148755, 61-62056, 61-62057, 61-118760, 2-42451, 3-41465, 4-212175, 4-214570, 4-263267, 5-34966, 5-119514, 6-59502, 6-161150, 6-175396, 6-219040, 6-230600, 6-295093, 7-36210, 7-43940, 7-56387, 7-56390, 7-64335, 7-199681, 7-223362, 7-287413, 8-184992, 8-227180, 8-248671, 8-2487799, 8-248801, 8-278663, 9-152739, 9-160278, 9-185181, 9-319139, 9-319413, 10-20549, 10-48889, 10-198069, 10-207116, 11-2917, 11-44969, 11-65156, 11-73049 and 11-194542. These compounds may be used individually or in any combination of two or more.

Examples of the silicone compounds include silicone oils, silicone rubbers, silicone fine particles, silicone-modified resins, reactive silicone compounds, etc. Examples of the silicone oils include non-modified silicone oils, amino-modified silicone oils, carboxy-modified silicone oils, carbinol-modified silicone oils, vinyl-modified silicone oils, epoxy-modified silicone oils, polyether-modified silicone oils, silanol-modified silicone oils, methacryl-modified silicone oils, mercapto-modified silicone oils, alcohol-modified silicone oils, alkyl-modified silicone oils, fluorine-modified silicone oils, etc.

Examples of the silicone-modified resins include silicone-modified products of olefin resins, polyester resins, vinyl resins, polyamide resins, cellulose resins, phenoxy resins, vinyl chloride-vinyl acetate resins, urethane resins, acryl resins, styrene-acryl resins, or copolymer resins of them.

Examples of the fluorine compounds include, but not limited to, fluorine oils, fluorine rubbers, fluorine-modified resins, fluorine sulfonate compounds, fluorosulfonic acids, fluorine compounds, salts of fluorine compounds, inorganic fluoride, etc.

The waxes are classified broadly into two types, namely natural waxes and synthetic waxes.

Examples of the natural waxes include vegetable waxes, animal waxes, mineral waxes and petroleum waxes. Among them, the vegetable waxes are especially preferable. In particular, water-dispersant natural waxes are preferred in light of compatibility in the case where an aqueous resin is used for a polymer of the toner image receiving layer.

Examples of the vegetable waxes include, but not limited to, waxes, commercially available or synthetic, conventionally known in the art. Specifically, examples of the vegetable waxes include carnauba waxes, one of which is commercially available as EMUSTAR-0413 (Ito Oil Manufacturing Co., Ltd.) or Serozole 524 (Chukyo Oils & Fats Co., Ltd.), castor oils one of which is fine castor oil commercially available from Ito Oil Manufacturing Co., colza oils, soybean oils, sumac waxes, cotton waxes, rice waxes, sugarcane waxes, canderyla waxes, Japan waxes, jojoba oils, etc. Among them, the carnauba waxes having melting temperatures in a range of from 70 to 95° C. are especially preferred in light of providing the electrophotographic image recording papers that excel in offset resistance, adhesion resistance, transportation quality and glossy impression, hardly cause cracks and form high quality images.

Examples of the animal waxes include, but not limited to, bees waxes, lanolin, spermaceti, blubber (whale oil), wool wax, etc. which are conventionally known in the art.

Examples of the mineral waxes include, but not limited to, waxes, commercially available or synthetic, conventional known in the art such as montan waxes, montan ester waxes, ozokerite, ceresin, etc. Among them, the montan waxes having melting temperatures in a range of from 70 to 95° C. are especially preferred in light of providing the electrophotographic image recording papers that excel in offset resistance, adhesion resistance, transport quality, glossy impression, hardly cause cracks and form high quality images.

Examples of the petroleum waxes include, but not limited to, waxes, commercially available or synthetic, such as paraffin waxes, microcrystalline waxes, petrolatum, etc. conventional known in the art,

It is preferred that the toner image receiving layer has the natural wax content in a range of from 0.1 to 4 g/m², and more preferably in a range of from 0.2 to 2 g/m². If the natural wax content is less than 0.1 g/m², significant deterioration in, in particular, offset resistance and adhesion resistance possibly is encountered. On the other hand, if the natural wax content is beyond 4 g/m², the wax is too much to prevent an occurrence of deterioration in image quality. It is preferred that the natural wax has a melting temperature in a range of from 70 to 95° C., and more preferably in a range of from 75 to 90° C., in light of, in particular, offset resistance and transport quality.

Examples of the synthetic waxes are classified into several types, namely synthetic hydrocarbons, modified waxes, hydrogenated waxes, and other fat and oil synthetic waxes. These waxes are preferred to be of a water-dispersant type in light of compatibility in the case where an aqueous thermoplastic resin is used in the toner image receiving layer.

Examples of the synthetic hydrocarbons include Fischer-Tropsch waxes, polyethylene waxes, etc. Examples of the fat and oil synthetic waxes include acid amide compounds such as amide stearate, acid imide compounds such as phthalic anhydride imide, etc.

Examples of the modified waxes include, but not limited to, amine-modified waxes, acrylic acid-modified waxes, fluorine-modified waxes, olefin-modified waxes, urethane type waxes, alcohol type waxes, etc. Examples of the hydrogenated waxes include, but not limited to, hydrogenated castor oils, derivatives of castor oils, stearic acids, lauric acids, myristic acids, palmitic acids, behenic acids, sebacic acids, undecylenic acids, heptyl acids, maleic acids, higher maleic oil, etc.

Various types of matting agents that are conventionally known in the art may be utilized. Solid particles used for the matting agents are classified into two types, namely inorganic particles and organic particles. Examples of materials for the inorganic matting agents include oxides such as silica dioxides, titanium oxides, magnesium oxides, aluminum oxides and the like; alkaline earth metal salts such as barium sulfate, calcium carbonate, magnesium sulfate and the like; silver halides such as silver chloride, silver bromide, and the like; and glass. Examples of the inorganic matting agents include those disclose in West Germany patent No. 2,529,321, British patent Nos. 760775 and 1,260,772, U.S. Pat. Nos. 1,201,905, 2,192,241, 3,053,662, 3,062,649, 3,257,206, 3,322,555, 3,353,958, 3,370,951, 3,411,907, 3,437,484, 3,523,022, 3,615,554, 3,635,714, 3,769,020, 4,021,245, and 4,029,504.

Examples of materials for the organic matting agents include starch, cellulose ester such as cellulose acetate propionate, cellulose ether such as ethyl cellulose, and synthetic resins. The synthetic resins are preferably water-insoluble or hardly water-soluble. Examples of the water-soluble or hardly water-soluble synthetic resins include poly(meth)acrylic ester such as polyalkyl acrylate, polyalkyl(meth)-acrylate, polyalkoxyalkyl(meth)acrylate, polyglycidyl (meth)acrylate; poly(meth)acrylamide; polyvinyl ester such as polyvinyl acetate; polyacrylo-nitrile; polyolefin such as polyethylene; polystyrene; benzoguanamine resins; formaldehyde condensed polymers; epoxy resins; polyamide; polycarbonate; phenol resins; polyvinyl carbazole; and polyvinyliden chloride. Copolymers comprising combinations of monomers used for the above mentioned polymers may be utilized. The copolymer may contain a small chain of hydrophilic repeating units. Examples of the monomers forming a hydrophilic repeating unit include acrylic acid, methacrylic acid, αβ-unsaturated carboxylic acid, hydroxyalkyl(meth)acrylate, sulfoalkyl(meth)acrylate, and styrene sulfonate.

Examples of the organic matting agents includes those described in British Patent No. 1,055,713, U.S. Pat. Nos. 1,939,213, 2,221,873, 2,268,662, 2,322,037, 2,376,005, 2391,181, 2,701,245, 2,992,101, 3,079,257, 3,262,782, 3,443,946, 3,516,832, 3,539,344, 3,591,397, 3,754,924 and 3,767,448, and Japanese Unexamined Patent Publication Nos. 49-106821 and 57-14835. The solid particles may be used individually or in any combination of two or more. The solid particles is preferred to have an average size in a range of from 1 to 100 μm, and more preferably in a range of from 4 to 30 μm. The amount of solid particles is preferably in a range of from 0.01 to 0.5 g/cm², and more preferably in a range of from 0.02 to 0.3 g/cm².

The releasing agents that are added into the toner image receiving layer as appropriate may consist of derivatives, oxides or refined articles or mixtures of the various materials mentioned above. These materials may have reactive substituents. It is preferred to use the water-dispersant releasing agents in light of compatibility in the case where an aqueous thermoplastic resin is used for the toner image receiving layer.

The releasing agents has a melting temperature preferably in a range of from 70° to 95° C., more preferably in a range of from 75° to 90° C., in light of, in particular, offset resistance and transport qualities through electrophotographic equipments. The releasing agent content of the toner image receiving layer is preferably in a range of from 0.1 to 10% by mass, more preferably in a range of from 0.3 to 8.0% by mass, and most preferably in a range of from 0.5 to 5.0% by mass. If the releasing agent content is less than 0.1% by mass, the toner image receiving layer possibly encounters a deterioration in offset resistance and adhesion resistance. On the other hand, if the releasing agent content is 10% by mass, the releasing agent is too much to prevent an occurrence of deterioration in image quality.

Plasticizer

Plasticizers are not bounded by their species and may take any type. Such a plasticizer has the function of controlling fluidization or a softening property of the toner image receiving layer due to heat and/or pressure applied in the toner fixing process. Examples of the plasticizers include, but not limited to, those disclosed in “Handbook Of Chemistry” by Chemical Society of Japan (Maruzen), “Plasticizer—Theory and Applications—” by Kouichi Murai (Koushobou), “Study On Plasticizer Vol. 1” and “Study On Plasticizer Vol. 2,” both by Polymer Chemistry Association, or “Handbook-Rubber Plastics Compounding Chemicals” (Rubber Digest Ltd.).

Examples of the plasticizers include those recited as high boiling organic solvents or thermal solvents in Japanese Unexamined Patent Publication Nos. 59-83154, 59-178451, 59-178453, 59-178454, 59-178455, 59-178457, 61-2000538, 61-209444, 62-8145, 62-9348, 62-30247, 62-136646, 62-174754, 62-245253, and 2-235694. Specific examples of the plasticizers recited in these publications include phthalate ester, phosphate ester, fatty ester, abietate, adipate easter, sebacate, azelate, benzonic ester, butyrate, epoxidized fatty ester, glycolate, propionate, trimellitate, citrate, sulfonate, calboxylate, succinate, maleate, phthalate or stearate, amide such as fatty amide or sulfoamide, ether, alcohol, lactone, polyethyleneoxy, etc. These plasticizers may be used as a mixture with a resin.

Polymers having comparatively low molecular weights can be used as the plasticizer. When using the polymers, it is preferred for the polymers to have molecular weights less than a binder resin that are to be plasticized. Specifically, the molecular weights of these polymers is preferably less than 15000, more preferably less than 5000. It is preferred for the polymeric plasticizers to be of the same type as a binder resin that is to be plasticized. For example, when plasticizing a polyester resin, it is preferred to use polyester having low molecular weights. It is also preferred to use oligomers as the plasticizer. Commercially available examples of the plasticizers other than the aforementioned compounds include Adecasizer PN-170 and Adecasizer PN-1430 (Asahi Denka Kogyo K.K.), PARAPLEX-G-25, PARAPLEX-G-30 and PARAPLEX-G-40 (C.P. HALL Corporation), and Estergum 8L-JA, Ester R-95, Pentaryn 4851, Pentaryn FK115, Pentaryn 4820, Pentaryn 830, Ruizol 28-JA, Picorastic A75, Picotex LC, and Crystalex 3085 (Rika Hercules Co., Ltd.).

It is possible to make optional use of the plasticizer in order to reduce stress or strain (physical strain due to elastic force or viscosity, or strain due to mass balance of molecules, binder main chains and pendants) that occurs when toner particles are buried in the toner image receiving layer. The plasticizer may be present in a microscopically dispersed state, a microscopically phase separated state like a sea-island state, or a state where the plasticizer has mixed with and dissolved in other components such as a binder sufficiently, in the toner image receiving layer. The plasticizer may be utilized for the purpose of optimizing slide quality (improvement of transport quality due to a reduction in frictional force), and of improving offset quality (separation of a toner), a curling balance and static build-up (formation of electrostatic toner image).

The plasticizer content of the toner image receiving layer is preferably in a range of from 0.001 to 90% by mass, more preferably in a range of from 0.1 to 60% by mass, and most preferably in a range of from 1 to 40% by mass.

Coloring Agent

Examples of coloring agents include, but not limited to, fluorescent brightening agents, white pigments, colored pigments, dye, etc.

Various fluorescent brightening agents conventionally known in the art can be used without any particular restriction as long as they have absorptive power in near-ultraviolet region and generate fluorescence in a wavelength band from 400 to 500 nm. Specifically, compounds disclosed in, for example, “The Chemistry of Synthetic Dyes” by K. Veen Ratarman, Vol. V, Chapter 8, may be used for the fluorescent brightening agent. Further, available examples of fluorescent brightening agent may include synthesized agents such as stilbene compounds, coumarin compounds, biphenyl compounds, benzoxazoline compounds, naphthalimide compounds, pyrazoline compounds, carbostyryl compounds, etc. and commercially available agents such as White Fulfa-PSN, White AFufa-PHR, White Fulfa-HCS, White Fulfa-PCS, White Fulfa-B (manufactured by Sumitomo Chemical Co., Ltd.) and UVITEX-OB (manufactured by Chiba-Geigy Ltd.).

Example of white pigment include, but not limited to, those conventionally known in the art, namely inorganic pigments such as titanium oxides, calcium carbonates, etc.

Examples of colored pigment include, but not limited to, various pigments such as disclosed in, for example, Japanese Unexamined Patent Publication No. 63-44653, azo pigments, polycyclic pigments, condensation polycyclic pigments, lake pigments, lake pigments, inorganic pigments, carbon black, etc. Examples of the azo pigments includes azolake such as carmine 6B, red 2B, etc.; insoluble azo pigments such as monoazo yellow, diazo yellow, pyrazolon orange, Balkan orange, etc.; condensed azo pigments such as chromophthal yellow and chromophthal red, and the like. Examples of the polycyclic pigments include phthalocyanine pigments such as copper phthalocyanine blue, copper phthalocyanine green, etc. Examples of the condensation polycyclic pigments include dioxazine pigments such as dioxazine violet, etc.; isoindolynone pigments such as indolynone yellow, etc.; slen pigments, perylene pigments, perynon pigments, thioindigo pigments and the like. Examples of the lake pigments include malachite green, rhodamine B, rhodamine G, Victoria blue B, etc. Examples of the inorganic pigments include oxides such as titanium dioxides, colcothar, etc.; sulfate such as precipitated barium sulfate, etc.; carbonates such as precipitated calcium carbonate, etc.; silicate such as hydrated silicate, anhydrous silicate, etc.; metal powder such as aluminum powder, bronze powder, blue powder, chrome yellow, iron blue; and the like. These colored pigments may be used individually or in any combination of two or more.

The dye can be selected from, but not limited to, those conventionally known in the art such as anthraquinone compounds and azo compounds. Examples of water-insoluble dye include vat dyes such as C.I.Vat violet 1, C.I.Vat violet 2, C.I.Vat violet 9, C.I.Vat violet 13, C.I.Vat violet 21, C.I.Vat blue 1, C.I.Vat blue 3, C.I.Vat blue 4, C.I.Vat blue 6, C.I.Vat blue 14, C.I.Vat blue 20, C.I.Vat blue 35, etc.; dispersive dyes such as C.I. disperse violet 1, C.I. disperse violet 4, C.I. disperse violet 10, C.I. disperse blue 3, C.I. disperse blue 7, C.I. disperse blue 58, etc.; and oil-soluble dyes such as C.I. solvent violet 13, C.I. solvent violet 14, C.I. solvent violet 21, C.I. solvent violet 27, C.I. solvent blue 11, C.I. solvent blue 12, C.I. solvent blue 25, C.I. solvent blue 55, etc. Colored couplers used in silver salt photography can be preferably utilized.

The coloring agent content is preferably in a range from 0.1 to 8 g/m², and more preferably in a range from 0.5 to 5 g/m², with respect to the toner image receiving layer. If the coloring agent content is less than 0.1 g/m², the toner image receiving layer has a light transmittance too high. On the other hand, if the coloring agent content is beyond 8 g/m², the toner image receiving layer is possibly apt to become poor in tractability concerning adhesion resistance and cracks. In particular among the coloring agents, the pigment content is preferably less than 40% by mass, more preferably less than 30% by mass, and most preferably less than 20% by mass, with respect to the mass of the thermoplastic resin in the toner image receiving layer.

Filler

Examples of fillers include various fillers, organic or inorganic, and those conventionally known in the art as stiffeners, loading materials and reinforcing materials for binder resins. The filler can be selected consulting “Handbook: Rubber-Plastics Composing Chemicals” (Rubber Digest Ltd.), “New Edition: Plastic Composing Chemicals: Fundamentals and Applications” (Taiseisha), and “Filler Handbook” (Taiseisha). Preferable examples of inorganic fillers and inorganic pigments available for the filler include silica, alumina, titanium dioxides, zinc oxides, zirconium oxides, mica-like ferric oxides, zinc white, lead oxides, cobalt oxides, strontium chromate, molybdenum pigments, smectite, magnesium oxides, calcium oxides, calcium carbonates, mullite, etc. Among them, silica and alumina are especially preferable. These fillers may be used individually or in any combination of two or more. It is desirable for the filler to have smaller particle sizes. If the filler particles are too large in size, the toner image receiving layer is apt to have a coarse surface.

There are two types of silica available for the filler, i.e. spherical silica and amorphous silica. These silica can be synthesized in either a wet process, a dry process or an aerogel process. It is allowed to treat surfaces of hydrophobic silica particles with a trimethylsilyl group or silicon. In this instance, it is preferred to use colloidal silica particles that are desirably porous.

There are two types of alumina available for the filler, i.e. anhydrous alumina and alumina hydrate. The anhydrous alumina may be of a crystal form of α, β, γ, ζ, η, θ, κ, ρ or λ. The alumina hydrate is more preferable rather than the anhydrous alumina. There are two types of alumina hydrate, namely monohydrate such as pseudoboehmite, boehmite and diaspore, and trihydrate such as gibbsite and bayerite. The alumina particles are preferably porous. The alumina hydrate can be synthesized in either a sol-gel process in which alumina hydrate is precipitated by adding ammonia in a solution of alminium salt or a hydrolysis process in which an alkali aluminate is hydrolyzed. The anhydrous alumina can be derived by heating and dehydrating an alumina hydrate.

The filler content is preferred to be between 5 to 2000 parts by mass with respect to 100 parts by dry mass of a binder in the toner image receiving layer.

Cross-Linking Agent

A cross-linking agent may be added in order to adjust storage stability and thermoplasticity of the toner image receiving layer. Examples of compounds available for the cross-linking agent include those having two or more reactive groups such as an epoxy group, an isocyanate group, an aldehydo group, an active halogen group, an active methylene group, an acetylene group or conventionally known reactive group, in one molecule. Aside from these compounds, available compounds are those having two or more groups capable of forming a bond through an ionic bond, a hydrogen bond, a coordinate bond, etc. Further examples of cross-liking agent include compounds conventionally known as a coupling agent, a hardening agent, a polymerizing agent, a polymerization promoter, a coagulating agent, a film forming ingredient, an auxiliary film forming ingredient and the like for resins. Examples of the coupling agent include chlorosilane, vinylsilane, epoxysilane, aminosilane, alkoxyaluminum chelate, titanate coupling agents and, additionally, include those disclosed in “Handbook: Rubber-Plastics Compounding Chemicals” (Rubber Digest Ltd.).

Electrostatic Charge Control Agent

It is preferred for the toner image receiving layer to contain an electrostatic charge control agent for the purpose of controlling toner transfer and toner adhesion. Examples of electrostatic charge adjusting agents include, but not limited to, various types of electrostatic charge control agents conventionally known in the art, namely surface-active agents such as cation surface-active agents, anion surface-active agents, amphoteric surface-active agents, nonion surface-active agents, etc. and, aside from those, polyelectrolytes, electroconductive metal oxides and the like. Specific examples of electrostatic charge control agent include cation antistatic agent such as quaternary ammonium salts, polyamine derivatives, cation-modified polymethylmethacrylate, cation-modified polystyrene, etc.; anionic antistatic agents such as alkylphosphate, anion polymers, etc.; and nonionic antistatic agents such as fatty ester, polyethylene oxides, etc. In the case where a toner is charged with negative electricity, the electrostatic charge control agent that is contained in the tone image receiving layer is preferably of a catyon type or of a nonion type.

Examples of the electroconductive metal oxide include ZnO, TiO₂, SnO₂, Al₂O₃, In₂O₃, SiO₂, MgO, BaO, MoO₃, etc. These electroconductive metal oxides may be used individually or in any combination of two or more thereof. The respective metal oxide may further contain, or may be doped with, hetero elements such as, for example, Al or In for ZnO, Nb or Ta for TiO₂, Sb, Nb or halogens for SnO₂.

Other Additives

The toner image receiving layer may contain other additives for the purpose of improving stability of image formation thereon and stability of the image recording layer itself. Examples of the other additives include antioxidants, anti-aging agents, anti-degradation agents, anti-ozonants, ultraviolet absorption agents, metal complexes, light stabilizers, antiseptic agents, fungicide, etc. which are well known in the art. Specific examples of the antioxidants include, but not limited to, chroman compounds, coumaran compounds, phenolic compounds such as hindered phenol, hydroquinone derivatives, hindered amine derivatives, spiroindan compounds, etc. The antioxidants that are disclosed in, for example, Japanese Unexamined Patent Publication No. 61(1986)-159644 can be use.

Examples of the anti-aging agents include, but not limited to, those disclosed in “Handbook: Rubber-Plastics Compounding Chemicals 2^{nd} Revised Edition” (1993, Rubber Digest Ltd.), pages 76-121.

Examples of the ultraviolet absorption agents include, but not limited to, benzotriazole compounds such as disclosed in U.S. Pat. No. 3,533,794, 4-thiazolidine compounds such as disclosed in U.S. Pat. No. 3,352,681, benzophenone compounds such as disclosed in Japanese Unexamined Patent Publication No. 46-2784, and ultraviolet absorption polymers such as disclosed in Japanese Unexamined Patent Publication No. 62-260152.

Examples of the metal complexes include, but not limited to, those disclosed in, for example, U.S. Pat. Nos. 4,241,155, 4,245,018 and 4,254,195, Japanese Unexamined Patent Publication Nos. 61-88256, 62-174741, 63-199248, 1-75568 and 1-74272. In addition, the ultraviolet absorption agents and the light stabilizers disclosed in “Handbook: Rubber Plastics Composing Chemicals 2^{nd} Revised Edition” (1993, Rubber Digest Ltd.), pages 122˜137 are preferably used.

Photographic additives conventionally well known in the photographic art can be added to the toner image receiving layer as appropriate. Examples of the photographic additives include those disclosed in Research Disclosure (RD) Nos. 17643 (December 1978), 18716 (November 1979) and 307105 (November 1989). Pages on which these additives appear are shown in Table I.

TABLE I

| Additive | RD No.17643 | RD No.18716 | RD No.307105 |
|---|---|---|---|
| Brightener | 24 | 648R | 868 |
| Stabilizer | 24-25 | 649R | 868-870 |
| Light Absorbent | 25-26 | 649R | 873 |
| (UV Absorbent) | | | |
| Color Dye Image | 25 | 650R | 872 |
| Stabilizer | | | |
| Film Hardener | 26 | 651L | 874-875 |
| Binder | 26 | 651L | 873-874 |
| Unstiffening Agent/ | 27 | 650R | 876 |
| Lubricant | | | |
| Coating Auxiliary | 26-27 | 650R | 875-876 |
| Agent | | | |
| (Surface-active | | | |
| Agent) | | | |
| Antistatic Agent | 27 | 650R | 976-977 |
| Matting Agent | | | 878-879 |

The toner image receiving layer of the image recording paper of the present invention is formed by applying a coating liquid containing a thermoplastic resin over the image recording paper support with, for example, a wire coater and drying it. A temperature for forming a thermoplastic resin film is preferably higher than an ambient temperature for storage before printing and less than 100° C. for fixation of toner particles.

It is preferred for the toner image receiving layer to have a dried spread desirably in a range from 1 to 20 g/cm² and more desirably in a range from 4 to 15 g/cm² and further to have a thickness desirably, but not limited to, greater than ½ of toner particle size and more desirably one to three times of toner particle size. More specifically, the thickness of the toner image receiving layer is preferably in a range of from 1 to 50 μm or in a range of from 1 to 30 μm, more preferably in a range of from 2 to 20 μm, and most preferably in a range of from 5 to 15 μm.

[Other Layers]

As was previously mentioned, the electrophotographic image recording paper or paper may be provided with other layers such as, for example, a surface protective layer, a backing layer, an adhesiveness improvement layer, an intermediate layer, an under coating layer, a cushioning layer, an electrostatic charge control (antistatic) layer, a reflection layer, a color tincture adjusting layer, a storage stability improvement layer, an anti-adhesion layer, an anti-curling layer, a smoothing layer, etc. These layers may be provided individually or in any combination of two or more.

Surface Protective Layer

The surface protective layer is formed on a surface of the electrophotographic image recording paper for the purpose of surface protection, improvement of storage stability, handling adaptability and pass-through ability to pass through ectrophotographic equipments, creation of writing adaptability and anti-offset ability. The protection layer may be single-layered or multi-layered. Although various types of thermoplastic resin binders or thermosetting resin binders can be blended in the surface protective layer, it is preferred to use the same type of binder resin as used in the toner image receiving layer. However, in this instance, the binder resin of the surface protective layer is not always necessarily the same in dynamic and electrostatic characteristics as those of the binder resin of the toner image receiving layer and can be optimized in dynamic and electrostatic characteristics appropriately. The surface protective layer may be further blended with various additives that are allowed to be blended in the toner image receiving layer such as, in particular, a matting agent or the like together with the releasing agent used in the electrophotographic image recording paper previously described. The matting agent may be selected from those conventionally known in the art. It is preferred for an outermost surface layer (e.g. a surface protective payer when it is formed) of the electrophotoelectric image recording paper to have better compatibility with a toner in light of fixing performance. Specifically, it is preferred for the outermost surface layer to have a contact angle with a molten toner in a range from 0 to 40°.

Backing Layer

The backing layer is formed preferably on a surface opposite to the toner image receiving layer of the base support for the purpose of creation of back surface printing adaptability and improvement of back surface printing quality, curling balance and pass-though ability to pass though electro-photographic equipments of the electrophotographic image recording paper. Though the backing layer is not always bound by color, it is preferred for the backing layer to be white in the case where the electrophotographic image recording paper is of two-sided. The backing layer has a degree of whiteness and a spectral reflecting coefficient both higher than 85% similarly to the front surface. In order to improve both-side printing adaptability, the backing layer may be the same in structure as that on the toner image receiving layer. Further, the backing layer may be blended with the various additives described above, appropriately such as a matting agent and an electrostatic charge control agent. In the case of using a roller lubricant oil for fixing rollers in order to prevent an occurrence of offset during fixation, the backing layer may be of an oleophic type. The backing layer may be single-layered or multi-layered inasmuch as having a thickness in a desirable range from 0.1 to 10 μm under normal conditions.

Adhesion Improvement Layer

The electrophotogreaphic image recording paper is preferably provided with an adhesiveness improvement layer for the purpose of improving adhesiveness between the toner image receiving layer and the base support. The adhesiveness improvement layer may be blended with various additives previously described,desirably such as a cross-linking agent.

<Cushioning Layer>

It is preferred for the electrophotographic image recording paper to have a cushioning layer between the adhesion improvement layer and the toner image receiving layer in order to improve toner acceptability

<Intermediate Layer>

The electrophotogreaphic image recording paper may be provided with an intermediate layer between the base support and the adhesiveness improvement layer, between the adhesiveness improvement layer and the cushioning layer, between the cushioning layer and the toner image receiving layer, and/or between the toner image receiving layer and the storage stability improvement layer. It is preferred that the intermediate layer comprises the same resin coating layer as applied to the toner image receiving layer described above. The intermediate layer contains at least a polymer and other components as appropriate. The polymer for the intermediate layer is not bounded as long as being available as the coating liquid applied to the toner image receiving layer. Among the polymers used for the toner image receiving layer, it is preferred to use the water-soluble polymers or the water-dispersant polymers, and more preferably the self-dispersant aqueous polymer emulsions or the water-dispersant acrylic resins, for the intermediate layer. Specific examples of the polymers for the intermediate layer include those satisfying the properties disclosed in Japanese Patent Publication No. 5-127413, Japanese Unexamined Patent Publication Nos. 8-194394, 8-334915, 8-334916, 9-171265 and 10-221877. The polymer content of the intermediate layer is preferably greater than 20% by mass, and more preferably in a range of from 30 to 100% by mass.

It is possible to make optional use of other additives described in connection with the toner image receiving layer unless they defunctionalize the intermediate layer. The intermediate layer can be comparatively easily formed by applying a coating liquid to the image recording paper support.

Heat-sensitive Printing Paper

An example of heat-sensitive printing paper is printing paper comprising, for example, the image recording paper support and at least one thermal color development layer formed on at least one surface of the image recording paper support that is used in the thermo autochrome printing process in which an image is formed by repeating application of heat and fixation by ultraviolet radiation with a thermal head.

Sublimation Transfer Printing Paper

The sublimation transfer recording paper comprises, for example, at least an ink layer containing thermal diffusion dye (sublimation dye) formed as an image recording layer on the base support of the present invention and is suitably with a sublimation transfer method by which an image is formed by selectively heating the ink layer with a thermal head to transfer the thermal diffusion dye to the sublimation transfer recording paper from the ink layer.

Thermal Transfer Printing Paper

The thermal transfer printing paper comprises, for example, at least a hot-melt ink layer formed as an image recording layer on the base support of the present invention and is suitably used with a melting transfer method by which an image is formed by selectively heating the hot-melt ink layer with a thermal head to transfer the molten ink to the thermal transfer printing paper.

Silver Salt Photographic Paper

The silver salt photographic paper comprises, for example, at least Y, M and C color development layers formed as an image recording layer on the base support of the present invention and is suitably used with a silver salt photographic method by which an image is formed by performing color development, breaching and fixation, washing and drying while an exposed silver salt photographic paper travels through processing tanks.

Ink-jet Printing Paper

The ink-jet printing paper comprises, for example, a color material receptive layer, that is capable of receiving a color material such as liquid inks, namely an aqueous ink (comprising dye or pigment as a color material) and an oil-based ink, and solid inks that are solid at a normal temperature and is melted and liquefied upon printing, formed as an image recording layer on the base support of the present invention.

### EXAMPLE

The following description will be directed to examples of the support and the image recording paper of the present invention, wherein the content is represented in mass percentage (%) or mass proportion (part).

(Practical Example I)

[Preparation of Image Recording Paper Support]

An image recording paper support of practical example I (PE I) was made by integrating a paper and a coating layer for an image recording surface on which an image recording layer is formed.

<Paper>

The paper was prepared in the following process. That is, first of all, a pulp stock having a fiber length of 0.60 mm was prepared by beating bleached broad leaf tree kraft pulp (LBKP) to a freeness of 300 ml in Canadian Standard Freeness (C.S.F.) with a disk refiner and being added with cation starch of 1.6%, alkylketene dimmer (AKD) of 0.4%, anion polyacrylamide of 0.3%, epoxidized fatty acid amide (EFA) of 0.2 and polyamide polyamine epichlorohydrin of 0.2%. The part of alkyl of the alkylketene dimmer is derived from a fatty acid primarily composed of behenic acid, and the part of fatty acid of the epoxidized fatty acid amide is derived from fatty acid primarily composed of behenic acid. The paper stock thus prepared was processed to make a wet paper sheet having an absolute dry basic weight of 140 g/m² and a moisture content of 68% using a manual paper machine.

The wet paper was put between filter sheets and dehydrated with a wet press machine so as to reduce the moisture content to 47%. The dehydrated wet paper was dried with a press-drying apparatus, specifically Static Condebelt (VALMET Coropration), shown in FIG. 1 until the moisture content is reduced to 7.0%. The press-drying apparatus was adjusted so as to keep the upper plate to be put in contact with the front surface of the paper on which an image recording layer is formed at 150° C. and the lower plate to be put in contact with the rear surface of the paper at 85° C. Drying was performed for one second under a pressure of 0.4 MPa Subsequently, the paper was processed with a celender machine with the front surface put in contact with a metal roll at a surface temperature of 250° C. and the rear surface put in contact with a resin roll at a surface temperature of 40° C. The paper was further backed with a polypropylene resin lamination film having a thickness of 30 μm, a melt flow rate (MFR) of 40 g/10 minutes, and a density of 0.90 g/cm³. The melt flow rate (MFR) was represented by a relative density measured at 23° C. by the method meeting JIS K7122. The polypropylene resin lamination film was formed in melt extrusion under the following film forming conditions.

Film forming condition:

Extrusion machine: Single spindle screw extrusion machine (Diameter: 60 mm)
Extrusion temperature: 305° C.
Nip pressure: 40 kgf/cm²
Cooling roll: Surface mat roughness of 10 μm, Surface temperature 15° C.
   <Coating Layer on Image Receiving Surface>

A coating layer was formed by extruding a resin composition under the following film forming conditions. The resin composition was prepared by mixing 50 parts of polypropylene resin and 50 parts of crystalline propylene copolymer by mass using a Banbury mixer and then melt kneading 80 parts of the resin mixture and 20 parts of petroleum resin such as Alcon P125 (Arakawa Chemical Inductry Co., Ltd.) together. The resin composition was adjusted so as to have a degree of crystallinity of 24%, a melt flow rate (MFR) of 4.2 g/10 minutes, and a density of 0.88 g/cm³, and the coating film was adjusted to a thickness of 30 μm. The following products were employed as the propylene resin and the crystalline propylene copolymer.

Propylene Resin:

Amorphous polypropylene, Tafseren (Sumitomo Chemical Co., Ltd.),
Density: 0.865 g/cm³
Melt flow rate (MFR): 3 g/10 minutes
   Crystalline Propylene Copolymer:
Propylene-ethylene random copolymer, Nobren WF732-1 (Sumitomo Chemical Co., Ltd.),
Melt flow rate (MFR): 5.5 g/10 minutes
Propylene unit content: 97% by mass
Ethylene unit content: 3% by mass
   Film Forming Conditions:
Extrusion machine: Single spindle screw extrusion machine (Diameter: 60 mm)
Extrusion temperature: 305° C.
Nip pressure: 40 kgf/cm²
Cooling roll: Surface mat roughness of 0.5 μm, Surface temperature 10° C.

The melt flow rate (MFR) was measured at 230° C. under a load of 21.2N by the method meeting JIS K7210, and the density was measured at 23° C. by the method meeting JIS K7112.

### Comparative Example I

An image recording paper support of comparative example I (CE I) was the same in structure as that of practical example I except to comprise the following coating layer for an image recording surface.

A coating layer was formed a resin composition that was prepared by melt kneading 100 parts of the same crystalline propylene copolymer as used in practical example I and then melt kneading 80 parts of the resin mixture and 20 parts of a petroleum resin such as Alcon P125 (Arakawa Chemical Inductry Co., Ltd.) together. The resin composition was adjusted so as to have a degree of crystallinity of 51%, a melt flow rate (MFR) of 5.5 g/10 minutes, and a density of 0.90 g/cm³. The coating film was formed under the following conditions and adjusted to a thickness of 30 μm.

Film Forming Conditions:

Extrusion machine: Single spindle screw extrusion machine (Diameter: 60 mm)
Extrusion temperature: 300° C.
Nip pressure: 35 kgf/cm²
Cooling roll: Surface mat roughness of 0.5 μm, Surface temperature 15° C.

The image recording paper supports of practical and comparative examples I were assessed on blister occurrence and flatness. The result is shown in Table II.

[Assessment of Blister Occurrence]

30 sheets of the image recording paper supports of each example were assessed on frequency of blister occurrence before and after passing through rollers kept at 150° C. and classified into the following four grades.

Assessment grade:

⊚ Perfectly no occurrence of blisters
◯ Blisters occurred in one sheet
Δ Blisters occurred in more than five sheets
X Blisters occurred in more than 15 sheets
   [Assessment of Flatness]

The image recording paper supports of each example were assessed on flatness based on fine concavity and convexity smaller than 1 mm and undulations in a range of from 5 to 6 mm through visual inspection by 20 inspectors and classified into the following five grades. Assessment grade for fine concavity and convexity
A: Very excellent (acceptable as a high quality image recording paper)
B: Excellent (acceptable as a high quality image recording paper)
C: Average (unacceptable as a high quality image recording paper)
D: Poor (unacceptable as a high quality image recording paper)
E: Very poor (unacceptable as a high quality image recording paper)
   Assessment grade for undulation
A: Very excellent (acceptable as a high quality image recording paper)
B: Excellent (acceptable as a high quality image recording paper)
C: Average (unacceptable as a high quality image recording paper)
D: Poor (unacceptable as a high quality image recording paper)

E: Very poor (unacceptable as a high quality image recording paper)

TABLE II

| | | | Flatness | |
|---|---|---|---|---|
| | Pencil | Occurrence of | Fine | |
| | hardness | blister | concavity/convexity | Undulation |
| PE 1 | H | ⊚ | A | A |
| CE 1 | H | Δ | D | E |

It is proved from Table II that the image recording paper supports of practical example I (PE I) are superior in blister and flatness in a hot environment to those of comparative example I(CE I).

### Practical Example II

[Preparation of Electrophotographic Printing Paper]

An electrophotographic printing paper of practical example II (PE II) was made using the image recording paper supports of practical example I in the following process.

<Dispersion Liquid of Titanium Dioxide>

A dispersion liquid of titanium dioxide was prepared by mixing and 40.0 g of titanium dioxide pigment, Taipek A-220 (Ishihara-sangyo Ltd.), 2.0 g of polyvinyl alcohol, PVA102 (Kuraray Co., Ltd.), and 58.0 g of ion-exchange water with a dispersion machine, Model NBK-2 (Nihon Seiki Co., Ltd.).

<Preparation of Coating Liquid for Toner Image Receiving Layer>

A coating liquid for the toner image receiving layer was prepared by mixing 15.5 g of the titanium dioxide dispersion liquid; 15.5 g of dispersion liquid of carnauba wax, Serozole 524 (Chukyo Oils & Fats Co., Ltd.); 100.0 g of water dispersion of polyester resin, KAZ-7049 (Unitika Ltd.), (a solid content: 30% by mass); 2.0 g of viscosity improver, Alcox (Meisei Chemical); 0.5 g of anion surface active agent (AOT); and 80 ml of ion-exchange water. Viscosity and surface tension of the coating liquid was adjusted to 40 mpa-s and 34 mN/m, respectively.

<Preparation of Coating Liquid for Backing Layer>

A coating liquid for the backing layer was prepared by mixing 100 g of water dispersion of acrylic resin, Hyros XBH-997L (Seiko Chemical Industry Co., Ltd.), (solid content: 30% by mass); 5.0 g of matting agent, Tecpolymer MBX-12 (Sekisui Chemical Co., Ltd.); 10.0 g of releasing agent, Hydrin D337 (Chukyo Oils & Fats Co., Ltd.); 2.0 g of viscosity improver (CMC); 0.5 g of anion surface active agent (AOT); and 80 ml of ion-exchange water. Viscosity and surface tension of the coating liquid was adjusted to 35 mpa-s and 33 mN/m, respectively.

[Coating of Toner Image Receiving Layer and Backing Layer]

A toner image receiving and a backing layer were formed on the front and rear surfaces of the image recording paper support of the practical example I, respectively, by coating the coating liquids prepared as above, respectively, using a bar coater and adjusted in dry mass to 12 g/m² and 9 g/m², respectively The toner image receiving layer was adjusted in pigment content to 5% by mass with respect to the thermoplastic resin.

The toner image receiving layer and the backing layer were coated on the image recording paper support and then dried by hot air. The amount and temperature of hot air flow was adjusted so that these layers dry out within two minutes. After drying, a calendar treatment was applied using a gloss calendar machine at a roller temperature of 40° C. and a nip pressure of 14.7 kN/m² (15 kgf/cm²). The electrophotographic printing paper was cut into A4 size paper sheets.

### Comparative Example II

An electrophotographic printing paper prepared as comparative example II (CE II) was the same as that of practical example II except for using the image recording paper support employed in comparative example I.

The electrophotographic printing papers of practical and comparative examples II were assessed on smoothness and glossiness. The result is shown in Table III.

[Assessment of Smoothness]

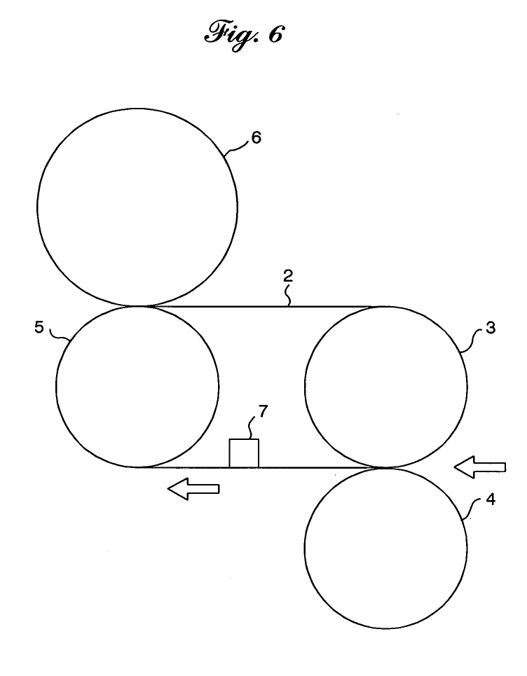

The smoothness was assessed by making prints using a color laser printer, DocuColor, Model 1250-PF (Fuji Xerox Co., Ltd.) with a belt fixing device 1 shown in FIG. 3 incorporated.

Referring to FIG. 3, the belt fixing device 1 comprises a heating roller 3, a tensioning roller 5, fixing belt 2 mounted between the heating roller 3 and the tensioning roller 5, a pressure roller 4, a cleaning roller 6 and a cooling device 7 disposed between the heating roller 3 and the tensioning roller 5. The fixing belt 2 passes through between the heating roller 3 and the pressure roller 4 and between the tensioning roller 5 and the cleaning roller 6. An electrophotographic printing paper bearing a latent toner image is inserted into a nip between the heating roller 3 and the pressure roller and conveyed by the fixing belt 2 from the right to the left as viewed in the figure. The electrophotographic printing paper is cooled by the cooling device 7 during conveyance between the heating roller 3 and the tensioning roller 5 and is cleaned by the cleaning roller 6. The belt fixing device was operated at a conveyance speed of 30 mm/second, a nip pressure of 0.2 MPa (2 kgf//cm²) and a heating temperature of 150° C. (a temperature of the heating roller 3) equal to the fixing temperature. In this instance, the pressure roller 4 was kept at 120° C.

The electrophotographic printing print of each example were assessed on surface smoothness based on fine concavity and convexity smaller than 1 mm and undulations in a range of from 5 to 6 mm through visual inspection by 20 inspectors and classified into the following five grades.

Assessment Grade for Fine Concavity and Convexity

A: Very excellent (acceptable as a high quality image recording paper)
B: Excellent (acceptable as a high quality image recording paper)
C: Average (unacceptable as a high quality image recording paper)
D: Poor (unacceptable as a high quality image recording paper)
E: Very poor (unacceptable as a high quality image recording paper)
   Assessment Grade for Undulation
A: Very excellent (acceptable as a high quality image recording paper)
B: Excellent (acceptable as a high quality image recording paper)
C: Average (unacceptable as a high quality image recording paper)
D: Poor (unacceptable as a high quality image recording paper)
E: Very poor (unacceptable as a high quality image recording paper)

Further, the electrophtographic printing paper of each example were assessed on surface glossiness through visual inspection by 20 inspectors and classified into the following five grades.

Assessment Grade for Glossiness

A: Very excellent (acceptable as a high quality image recording paper)
B: Excellent (acceptable as a high quality image recording paper)
C: Average (unacceptable as a high quality image recording paper)
D: Poor (unacceptable as a high quality image recording paper)
E: Very poor (unacceptable as a high quality image recording paper)
   [Delamination, Peeling, Swell]

30 sheets of the electrophotographic paper of each example were assessed on frequency of occurrences of delamination, peeling and/or swells after passing through the heating rollers kept at 150° C. and classified into the following four grades.

Assessment Grade:

⊚ Perfectly no occurrence of delamination, peeling and/or swells
◯ Delamination, peeling and/or swells occurred in one sheet
Δ Delamination, peeling and/or swells occurred in more than five sheets

X Delamination, peeling and/or swells occurred in more than 15 sheets

TABLE III

Occurrence of

| | |
|---|---|
| Smoothness | delamination, |

| | Fine | | | peeling and/ |
|---|---|---|---|---|
| | concavity/convexity | Undulation | Glossiness | or swells |
| PE II | A | A | A | ⊚ |
| CE II | E | D | C | Δ |

It is proved from Table III that the electrophotographic printing paper of practical example II (PE II) are superior in smoothness, glossiness, delamination resistance, etc to those of comparative example II (CE II).

As described above, the image recording paper support and the image recording paper of the present invention are capable of preserving its flatness even after high-temperature heating. Furthermore, the image recording paper support and the image recording paper are capable of providing high quality prints having high glossiness and high smoothness and, in consequence, are suitable for full color printing or photographic printing, and especially for electrophotographic printing, heat sensitive printing, sublimatic transfer printing, thermal development printing, silver halide photographic printing, ink-jet printing and the like.

It is to be understood that although the present invention has been described with regard to a preferred embodiments thereof, various other embodiments and variants may occur to those skilled in the art, which are within the scope and spirit of the invention, and such other embodiments and variants are intended to be covered by the following claims.

1. An image recording paper support comprising:
a support paper; and
a coating layer formed on at least one surface of said support paper on which an image is formed;
wherein said coating layer contains a propylene resin having a density less than 0.88 g/cm³.

2. The image recording sheet support as defined in claim 1, wherein said propylene resin is amorphous.

3. The image recording sheet support as defined in claim 2, wherein said coating layer formed on said one surface of said support paper has a polypropylene resin content greater than 5% by mass.

4. The image recording sheet support as defined in claim 1, wherein said propylene resin is selected from a group consisting of a polypropylene resin, copolymers of propylene and ethylene and copolymers of propylene and butene.

5. The image recording sheet support as defined in claim 1, wherein said coating layer formed on said one surface of said support paper has a polypropylene resin content greater than 5% by mass.

6. The image recording sheet support as defined in claim 1, wherein said coating layer formed on said one surface of said support paper further contains a crystalline propylene resin.

7. The image recording sheet support as defined in claim 6, wherein a crystalline propylene resin content of said coating layer is less than 95% by mass.

8. The image recording sheet support as defined in claim 1, wherein said propylene resin has a met flow rate in a range of from 0.5 to 6 g/10 seconds at 230° C.

9. The image recording sheet support as defined in claim 1, wherein said support paper has a density in a range of from 0.85 to 1.15 g/cm³.

10. The image recording sheet support as defined in claim 1, wherein said support paper is pressure dried before application of said coating layer.

11. The image recording sheet support as defined in claim 10, wherein said support paper is calendered before application of said coating layer.

12. The image recording sheet support as defined in claim 11, wherein said support paper is calendered with a calender with a metal roll kept at 140° C.

13. The image recording sheet support as defined in claim 1, wherein said support paper is used as printing paper.

14. An image recording paper support comprising:
a support paper; and
a coating layer formed on at least one surface of said support paper on which an image is formed;
wherein said coating layer contains an amorphous polyolefin resin.

15. The image recording sheet support as defined in claim 14, wherein said amorphous polyolefin resin comprises a propylene resin.

16. The image recording sheet support as defined in claim 5, wherein said amorphous polyolefin resin has a met flow rate in a range of from 0.5 to 6 g/10 seconds at 230° C.

17. The image recording sheet support as defined in claim 16, wherein said coating layer formed on said one surface of said support paper further contains a crystalline propylene resin.

18. The image recording sheet support as defined in claim 17, wherein a crystalline propylene resin content of said coating layer is less than 95% by mass.

19. The image recording sheet support as defined in claim 16, wherein said propylene resin has a met flow rate in a range of from 0.5 to 6 g/10 seconds at 230° C.

20. The image recording sheet support as defined in claim 16, wherein said support paper has a density in a range of from 0.85 to 1.15 g/cm³.

21. The image recording sheet support as defined in claim 14, wherein said support paper is pressure dried before application of said coating layer.

22. The image recording sheet support as defined in claim 21, wherein said support paper is calendered before application of said coating layer.

23. The image recording sheet support as defined in claim 22, wherein said support paper is calendered with a calender with a metal roll kept at 140° C.

24. The image recording sheet support as defined in claim 14, wherein said support paper is used as printing paper.

25. An image recording paper comprising said image recording paper support as defined in any one of the preceding claims 1 through 24 and an image recording layer.

26. The image recording paper as defined in claim 25, wherein said image recording layer is formed on said one surface.

27. The image recording paper as defined in claim 25, wherein said image recording layer comprises a resin coating layer.

28. The image recording paper as defined in claim 25, and further comprising an intermediate layer between said image recording paper support and said image recording layer.

29. The image recording paper as defined in claim 28, wherein said intermediate layer comprises a resin coating layer.

30. The image recording paper as defined in claim 28, wherein said resin coating layer is formed by applying a coating liquid of aqueous polymer.

31. The image recording paper as defined in claim 30, wherein said aqueous polymer comprises either one of a water-dispersant polyester resin and a water-dispersant acryl resin.

32. The image recording sheet support as defined in claim 25, wherein said image recording paper is used as at least one of electrophotographic printing paper, heat sensitive printing paper, sublimatic transfer printing paper, thermal development printing paper, silver halide photographic printing paper and ink-jet printing paper.
